(19) United States
(12) Patent Application Publication
(10) Pub. No.: US 2024/0279431 A1
(43) Pub. Date: Aug. 22, 2024

(54) Fluid Plasticizers Including Fluorinated Organic Compounds for Use in Curable Fluoropolymer Compositions and Fluoroelastomer Compositions, and Methods for Improving Processability and Low Temperature Use Properties of Such Compositions

(71) Applicant: Greene, Tweed Technologies, Inc., Wilmington, DE (US)

(72) Inventors: Ronald R. Campbell, Lansdale, PA (US); Mookkan Periyasamy, Wilmington, DE (US)

(21) Appl. No.: 18/509,232

(22) Filed: Nov. 14, 2023

Related U.S. Application Data
(60) Provisional application No. 63/383,663, filed on Nov. 14, 2022.

(51) Int. Cl. C08K 5/06; C08L 27/16; C08L 27/18; C08L 27/20

(52) U.S. Cl. CPC C08K 5/06; C08L 27/16; C08L 27/18; C08L 27/20; C08L 2205/06

(57) ABSTRACT

Curable fluorine-containing compositions and fluoroelastomer compositions are described herein that provide for reduction in viscosity and improvement in processability, as well as a lowering of a lowest use temperature of a fluoroelastomer by incorporating in such compositions a fluid plasticizer that includes at least one, at least partially fluorinated organic compound and that is capable of reducing viscosity and improving processability of a fluoroelastomer formed from a curable fluorine-containing polymer in comparison to a fluoroelastomer formed from the same curable fluorine-containing polymer without the at least one, at least partially fluorinated organic compound and/or that is capable of achieving a lowest use temperature of a fluoroelastomer formed from the curable fluorine-containing polymer that is lower than a lowest use temperature of a fluoroelastomer formed from the same curable fluorine-containing polymer without the at least one, at least partially fluorinated organic compound. Methods of improving processability and/or reducing viscosity and/or lowering the lowest use temperature of a fluoroelastomer are also described.

### CROSS-REFERENCE TO RELATED APPLICATIONS

This U.S. non-provisional patent application claims the benefit under 35 U.S.C. § 119(e) of U.S. Provisional Patent Application No. 63/383,663, filed Nov. 14, 2022, entitled, “Fluid Plasticizers Including Fluorinated Organic Compounds for Use in Curable Fluoropolymer Compositions, and Methods for Improving Processability and Low Temperature Use Properties of Such Compositions,” the entire disclosure of thereof is incorporated herein by reference.

### BACKGROUND OF THE INVENTION

### Field of the Invention

The invention is related the field of improving processability and/or the low temperature use properties of fluoroelastomer compositions, and particularly related to improving processability and low temperature use of perfluoroelastomer compositions.

### Description of Related Art

Elastomers in varying classes have their own characteristic glass transition values (Tg). When such elastomers have a Tg value that is not as low as desired for a particular end use, a compounder may, e.g., add a processing oil or organic compound known in the art to lower the Tg. These materials permeate the elastomer structure, and moving polymer segments appear thereby allowing molecular motion at a lower temperature. However, this technique has proven to have little benefit with respect to fluoroelastomers (a class of polymers known as FKMs under the ASTM standard Rubber Nomenclature), and particularly perfluoroelastomers (known as FFKMs). For such materials there has been little that can be done to change the Tg through use of additives such as those useful in other elastomers and such materials are also known to have processability issues.

Attempts have been made to make FKM materials more processable by using additives that may lower hardness and/or modulus with a result of possibly reducing the Tg of an FKM about 1° C. to about 3° C. However, such additives may impact other material properties, including processability or the physical or elastomeric properties associated with the FKM or FFKM.

Finding a suitable solution to improve processability and to adjust the Tg of FKM/FFKMs in the fluoroelastomer art has proven to be difficult. Prior attempts to use plasticizers known to be useful in other elastomers has not resolved this issue for FKMs and FFKMs which are typically employed in end uses involving harsh chemicals or plasma materials due to their high level of chemical resistance, and also in high temperature and/or high process processing environments. Such end uses may also occur at temperatures that exceed the useful operation temperatures of other rubber plasticizers.

One approach used in the art to improve processing of FFKMs includes the addition of various oils such as mineral oil, plant-derived oil or perfluoropolyether fluids as described in U.S. Pat. No. 10,023,722. Such materials are helpful but have limited impact on the ability to use FFKMs at lower temperatures or to modify viscosity for processability. As a result, FKMs/FFKMs are difficult to process requiring compounding, extrusion and then heat within molds.

Thus, to date, there is a need in the art to improve the processability of FKMs/FFKMs, including when processing at the processing temperatures and conditions typically associated with use of such highly chemical- and plasma-resistant materials, and which further can improve the low temperature properties of such materials for more extreme use environments.

### BRIEF SUMMARY OF THE INVENTION

The invention herein provides a curable fluorine-containing composition, comprising a curable fluorine-containing polymer; and at least one fluid plasticizer comprising at least one, at least partially fluorinated organic compound, wherein the at least one, at least partially fluorinated organic compound is capable of reducing viscosity and improving processability of a fluoroelastomer formed from the curable fluorine-containing polymer in comparison to a fluoroelastomer formed from the same curable fluorine-containing polymer without the at least one, at least partially fluorinated organic compound; and/or wherein the at least one, at least partially fluorinate organic compound is capable of achieving a lowest use temperature of a fluoroelastomer formed from the curable fluorine-containing polymer that is lower than a lowest use temperature of a fluoroelastomer formed from the same curable fluorine-containing polymer without the at least one, at least partially fluorinated organic compound.

In one embodiment, the composition further comprises at least one curative capable of curing the fluorine-containing polymer. The curable fluorine-containing polymer may be selected from the group consisting of an at least partially fluorinated curable fluoropolymer (which may form an FKM), a perfluorinated curable fluoropolymer (which may form an FFKM), an at least partially fluorinated curable copolymer of tetrafluoroethylene and propylene (which may form an FEPM) or an at least partially fluorinated curable silicon-containing polymer (which may form an FVMQ).

In a further embodiment, the curable fluorine-containing polymer is a curable perfluorinated polymer (which may form an FFKM). In such an embodiment, the curable perfluorinated polymer may be a copolymer of tetrafluoroethylene, perfluoroalkylvinyl ether and at least one cure site monomer, wherein the at least one cure site monomer has a cure site that comprises a halogen atom or a nitrile group.

Further, in another embodiment, the curable fluorine-containing polymer may be a curable fluoropolymer that is at least partially fluorinated and includes a vinylidene fluoride monomer along its backbone. In such an embodiment, the curable fluoropolymer may further comprise hexafluoropropylene and tetrafluoroethylene as co-monomers with the vinylidene fluoride.

The at least one, at least partially fluorinated organic compound may be selected from alkoxy fluoroalkanes, alkoxy fluoroalkenes, alkenoxy fluoroalkanes, alkenoxy fluoroalkenes, alkoxy perfluoroalkanes, alkoxy perfluoroalkenes, alkenoxy perfluoroalkanes, alkenoxy perfluoroalkenes, and combinations and mixtures thereof.

The at least one, at least partially fluorinated organic compound may be a compound according to Formula (A):

(R_{af})(R_{b})_{y}—O—R_{c} (A)

wherein R_{af} may be a fluorinated alkane or alkene group of from 4 to 20 carbon atoms, the fluorinated alkane or alkene group may be branched or straight chain and the fluorinated alkane or alkene group may comprise about 4 to about 41 fluorine atoms; R_{b} may be an alkane of from about 2 to 5 carbon atoms; y may be 0 or 1. When y is 1, R_{b} may be on a terminal end of R_{af}, or may be within or depending from the carbon chain of R_{af}. R_{c} may be an alkane or alkene group of 2 to 7 carbon atoms and optionally may have from 1 to about 3 fluorine atoms on the carbon atoms of the alkane or alkene group.

In one embodiment, Rₐ and R_{b} may be collectively from 4 to about 15 carbon atoms. Rₐ may also be perfluorinated.

The O—R_{c} group may be a pendant alkoxy group or a pendant alkenoxy group on the carbon chain of (R_{af})(R_{b}) y. O—R_{c} may be an alkoxy group of about 2 to about 5 carbons.

In embodiments herein, the at least one, at least partially fluorinated organic compound may be selected from methoxydecafluoroheptane and isomers thereof; ethoxy-nonafluorobutene ether or ethoxy-nonafluoroisobutyl ether isomers; ethoxy-trifluoromethylhexanes and isomers and derivatives thereof; and mixtures and combinations thereof. In another embodiment, the at least one, at least partially fluorinated organic compound may be 3-ethoxy-1,1,1,2,3,4,5,5,6,6,6-dodecafluoromethylhexane.

The at least one, at least partially fluorinated organic compound may be present in the composition at an amount of about 1 to about 20 parts by weight per hundred parts of the at least one curable fluorine-containing polymer, or in an amount of about 3 to about 15 parts by weight per hundred parts of the at least one curable fluorine-containing polymer.

The composition may further comprise one or more additives or fillers different from the at least one fluid plasticizer comprising the at least one, at least partially fluorinated organic compound, wherein the one or more additives or fillers may be present in the composition in an amount of up to about 95 parts by weight per 100 parts of the curable fluorine-containing polymer. In one embodiment, the curable fluorine-containing composition is an additive manufacturing composition for use in printing a fluorine-containing elastomer article.

The invention also includes a cured fluoroelastomer composition comprising: a fluoroelastomer that is at least partially cured; and at least one, at least partially fluorinated organic compound in the matrix of the fluoroelastomer, wherein the at least one, at least partially fluorinated organic compound is incorporated in the matrix of the fluoroelastomer in a fluid plasticizer; wherein the fluoroelastomer in the composition has a reduced viscosity and improved processability in comparison to a fluoroelastomer that is the same as the fluoroelastomer in the composition but does not include the at least one, at least partially fluorinated organic compound; and/or wherein a lowest use temperature of the fluoroelastomer in the composition is lower than a lowest use temperature of a fluoroelastomer that is the same as the fluoroelastomer in the composition but does not include the at least one, at least partially fluorinated organic compound.

In one embodiment, a Tg of the fluoroelastomer in the composition, as measured in ° C., is at least about 30% lower than a Tg of a fluoroelastomer that is the same as the fluoroelastomer in the composition but that does not include the at least one, at least partially fluorinated organic compound.

In a further embodiment, the minimum torque value (ML), as measured in lb-in, of a fluoroelastomer in the composition is at least about 50% lower than a minimum torque value of a fluoroelastomer that is the same as the fluoroelastomer in the composition but that does not include the at least one, at least partially fluorinated organic compound.

The fluoroelastomer in the composition may be selected from a cured at least partially fluorinated elastomer, a cured perfluoroelastomer, a cured at least partially fluorinated tetrafluoroethylene-propylene fluoroelastomer, and a cured at least partially fluorinated fluorosilicone. The fluoroelastomer in the composition may be a perfluoroelastomer.

The at least one, at least partially fluorinated organic compound in the composition may be selected from alkoxy fluoroalkanes, alkoxy fluoroalkenes, alkenoxy fluoroalkanes, alkenoxy fluoroalkenes, alkoxy perfluoroalkanes, alkoxy perfluoroalkenes, alkenoxy perfluoroalkanes, alkenoxy perfluoroalkenes, and combinations and mixtures thereof.

In another embodiment of the fluoroelastomer composition, the at least one, at least partially fluorinated organic compound may be a compound according to Formula (A)

(R_{af})(R_{b})_{y}—O—R_{c} (A)

wherein R_{af} may be a fluorinated alkane or alkene group of from 4 to 20 carbon atoms, the fluorinated alkane or alkene group may be branched or straight chain and the fluorinated alkane or alkene group may comprise about 4 to about 41 fluorine atoms. R_{b} may be an alkane of from about 2 to 5 carbon atoms; and y may be 0 or 1. When y is 1, R_{b} may be on a terminal end of R_{af}, or is within or depending from the carbon chain of Rₐ. R_{c} may be an alkane or alkene group of 2 to 7 carbon atoms and optionally have from 1 to about 3 fluorine atoms on the carbon atoms of the alkane or alkene group.

In one embodiment, Rₐ and R_{b} are collectively from 4 to about 15 carbon atoms. Rₐ may be perfluorinated. The O—R_{c} group may be a pendant alkoxy group or a pendant alkenoxy group on the carbon chain of (R_{af})(R_{b})_{y}. O—R_{c} may be an alkoxy group of about 2 to about 5 carbons.

In another embodiment, the at least one, at least partially fluorinated organic compound may be selected from methoxydecafluoroheptane and isomers thereof; ethoxy-nonafluorobutene ether or ethoxy-nonafluoroisobutyl ether isomers; ethoxy-trifluoromethylhexanes and isomers and derivatives thereof; and mixtures and combinations thereof. In another embodiment, the at least one, at least partially fluorinated organic compound is 3-ethoxy-1,1,1,2,3,4,5,5,6,6,6-dodecafluoromethylhexane

In yet a further embodiment, the at least one, at least partially fluorinated organic compound may be present in the fluoroelastomer composition at an amount of about 1 to about 20 parts by weight per hundred parts of the fluoroelastomer. The at least one, at least partially fluorinated organic compound may be present in the fluoroelastomer composition in an amount of about 3 to about 15 parts by weight per hundred parts of the fluoroelastomer.

The fluoroelastomer composition may further comprise one or more additives or fillers different from the at least one, at least partially fluorinated organic compound, wherein the one or more additives or fillers are present in the composition in an amount of up to about 95 parts by weight per 100 parts of the fluoroelastomer.

The invention also includes a method for improving viscosity and processability of a fluoroelastomer by providing to a matrix of the fluoroelastomer at least one, at least partially fluorinated organic compound, wherein the at least one, at least partially fluorinated organic compound is at least partially incorporated in the matrix of the fluoroelastomer in a fluid plasticizer.

In the method, the at least one, at least partially fluorinated organic compound may be provided to the fluoroelastomer by incorporating the fluid plasticizer into a composition comprising a curable fluorine-containing polymer prior to curing the curable fluorine-containing polymer composition to form the fluoroelastomer. In one embodiment, the method may further comprise introducing the composition into an additive manufacturing process prior to curing the curable fluorine-containing polymer composition to form the fluoroelastomer.

Further, the at least one, at least partially fluorinated organic compound may be provided to the curable fluorine-containing polymer in an amount of about 1 to about 20 parts by weight per hundred parts by weight of the curable fluorine-containing polymer.

The invention further includes a method of reducing the lowest use temperature of a fluoroelastomer by providing to at matrix of the fluoroelastomer at least one, at least partially fluorinated organic compound, wherein the at least one, at least partially fluorinated organic compound is at least partially incorporated into the matrix of the fluoroelastomer in a fluid plasticizer. In the method the Tg of the fluoroelastomer is also reduced by the at least one, at least partially fluorinated organic compound. In a further embodiment of the method, the at least one, at least partially fluorinated organic compound may be provided to the fluoroelastomer by incorporating the fluid plasticizer into a composition comprising a curable fluorine-containing polymer prior to curing the curable fluorine-containing polymer composition to form the fluoroelastomer.

The invention further includes a method of lowering the viscosity and improving the processability of a composition comprising a first curable fluorine-containing polymer having a Mooney viscosity (ML 1+10@ 121° C.) of about 30 to about 160, or of a molded article formed from the composition, comprising incorporating into the composition at least one second curable fluorine-containing polymer having a Mooney viscosity (ML 1+10@ 121° C.) of about 10 to about 45, and wherein the Mooney viscosity of the second curable fluorine-containing polymer is selected to be lower than the Mooney viscosity of the first curable fluorine-containing polymer. One or more plasticizers may be incorporated in the composition, and the composition may be introduced to an additive manufacturing process.

In one embodiment, the first fluorine-containing polymer and the second fluorine-containing polymer may be blended, alloyed or copolymerized. The composition may further comprise at least one fluid plasticizer having at least one, at least partially fluorinated organic compound as noted above, and the composition may be introduced to an additive manufacturing process. One or more additional plasticizers different from the at least one fluid plasticizer may be used in such an embodiment.

### BRIEF DESCRIPTION OF THE SEVERAL VIEWS OF THE DRAWINGS

The foregoing summary, as well as the following detailed description of preferred embodiments of the invention, will be better understood when read in conjunction with the appended drawings. For the purpose of illustrating the invention, there is shown in the drawings embodiments which are presently preferred. It should be understood, however, that the invention is not limited to the precise arrangements and instrumentalities shown. In the drawings:

FIG. 1 is a graphical representation of the thermogravimetric analysis (TGA) of Control Sample A, and inventive Samples A1, A2 and A3 of Examples 1 and 3;

FIG. 2 is a graphical representation of the differential scanning colorimetry analysis of Control Sample A, and inventive Samples A1, A2 and A3 in Examples 1 and 3;

FIG. 3 is a graphical representation of the low temperature O-ring leak tests of Control Samples A, B and C, and inventive Samples A1, A2, and A3, and B1, B2 and B3 and C1, C2 and C3 from Examples 1 and 2;

FIG. 4 is a graphical representation of a RPA analysis of Sample Compounds 1, 3, 6 and 8 of Example 4 showing the increase in torque (ML) measured in dN-m over time at 100° C.; and

FIG. 5 is a graphical representation of ML at 100° C. and post-print shrinkage (%) for each of Compounds 1, 3, 6 and 8 of Example 4.

### DETAILED DESCRIPTION OF THE INVENTION

The invention herein provides a method to improve processability of fluorine-containing curable polymers for forming elastomers and curable compositions and resulting elastomers that have enhanced processability. The elastomers formed from the fluorine-containing curable polymers are preferably fluoroelastomers, and may be perfluorinated or at least partially fluorinated elastomers of a variety of types. In one embodiment, the invention includes compositions including such fluoroelastomers having improved processability, as well as new fluorinated organic compounds that act as plasticizers, and in some embodiments as super plasticizers, for the curable fluoropolymers in a curable fluoropolymer compositions and/or for the resulting cured fluoroelastomers. Such plasticizers having at least partially or fully fluorinated organic compounds that improve processability substantially so as to allow the processing of these materials using more traditional heat processing techniques, such as injection molding, and can be used to enhance the ability to incorporate fluoroelastomers in three-dimensional printing applications.

In three-dimensional printing, attempts to develop three-dimensionally printed parts formed from fluoroelastomers to date have been challenging in view of the processability difficulties presented by such curable fluorinated materials and their resulting cured elastomers. Efforts have focused on attempts to modify the three-dimensional printing apparatuses to facilitate an extrusion while controlling the timing and cure cycle, addition of prior art processing aids, and/or modifying of printing head design or conditions. The present invention provides improvements instead by substantially increasing the processability of the curable fluoropolymers themselves and the resulting elastomers such that three-dimensional printing may be undertaken more easily.

In another embodiment, processability of curable fluoropolymers in three-dimensional printing is improved by use of blended curable fluoropolymers so as to reduce the Mooney viscosity of the curable fluoropolymers for printing.

In addition to enhancing the processability of curable fluoropolymer compositions, the present invention further demonstrates a method for improving the low temperature use of fluoroelastomers formed from such compositions by modifying the Tg of the fluoroelastomers. The invention thus provides a composition and resulting fluoroelastomer after cure with a decreased low temperature processing range that is significantly below those currently achieved using the same curable fluoropolymer but without a fluid plasticizer as described herein that includes at least one fluorinated organic compound herein and without substantially impacting the beneficial properties associated with use of the resulting fluoroelastomers and articles formed therefrom which are known for their high levels of chemical- and plasma-resistance.

The improvements may be realized both before and/or after curing of the elastomer, and can be indicated by a drop in viscosity of the elastomer, a drop in the Tg, a reduction in hardness and/or an average lowering of the TR10 value. Addition of the plasticizers described herein after cure, such as by soaking an at least partially cured elastomer in a fluid plasticizer, such as a liquid plasticizer, may also be achieved. The fluid plasticizers herein including the at least partially fluorinated organic compounds used herein, provides significant advantages and acts as a plasticizer for fluoroelastomeric materials, and in preferred embodiments as a super plasticizer for fluoroelastomeric materials.

In embodiments herein, the compositions include at least one fluid plasticizer including at least one, at least partially fluorinated organic compound and is in the form of a class of specialty fluids or engineered fluids typically used as heat transfer fluids or as replacements for chlorofluorocarbons as having less ozone depletion potential (ODP) and less global warming potential (DWP). Such fluids are used as solvents for various materials and in heat transfer applications.

In evaluating such fluids for other end uses, applicant unexpectedly discovered the ability of such fluorinated organic compounds to not only lower the viscosity of fluoroelastomers, but also to substantially improve their processability and also to enhance the low temperature processing temperature range for fluoroelastomers as well. Such specialty fluids and engineered heat transfer fluids are thus useful in the invention herein.

Preferred specialty fluids or engineered fluids are fluid compounds (in this case they are fluids that are primarily liquids) that include one or more at least partially fluorinated organic compounds capable of reducing the viscosity and improving processability of fluoroelastomers as described herein and/or are capable of lowering the useful service temperature of fluoroelastomers by lowering the Tg of the fluoroelastomer.

In one embodiment herein, the at least partially fluorinated organic compounds are provided in fluid form so as to act as a fluid plasticizer. They may be the only compound in the fluid plasticizer or the fluid plasticizer may incorporate one or more of the at least partially fluorinated organic compounds and/or other additives. The at least partially fluorinated organic compounds are selected from alkoxy fluoroalkanes, alkoxy fluoroalkenes, alkenoxy fluoroalkanes, alkenoxy fluoroalkenes, alkoxy perfluoroalkanes, alkoxy perfluoroalkenes, alkenoxy perfluoroalkanes, alkenoxy perfluoroalkenes, and combinations and mixtures thereof

In other embodiments herein, preferred fluorinated organic compounds are in a group of at least partially fluorinated organic compounds that have one or more functional groups, such as an alkoxy group, thereon, and that may be, for example, expressed according to Formula (A):

(R_{af})(R_{b})_{y}—O—R_{c} (A)

Wherein R_{af} is a fluorinated alkane group of from four to 20 carbon atoms which may be branched or straight chain and which may include from about 4 to about 41 fluorine atoms, and R_{b} is an alkane of from about 2 to 5 carbon atoms. In formula (A), y may be 0 or 1.
If y is 1, R_{b} may be incorporated at either or both of a terminal end of R_{af} or within the chain of R_{af} in either the backbone thereof or in a branched manner so as to be pendant from R_{af}.
R_{c} is an alkane or alkene group of 2 to 7 carbon atoms and optionally may have from 1 to about 3 fluorine atoms on the carbon atoms. Preferably R_{af} and R_{b} are collectively from about 4 to about 15 carbon atoms in a chain, which may be a straight chain or a branched chain, and are each mostly fluorinated, and in some embodiments are perfluorinated.
The O—R_{c} group may be positioned on a terminal end of (R_{af})(R_{b})_{y} or connected to the backbone chain thereof as a pendant alkoxy group or alkenoxy group. Preferably the O—R_{c} group is an alkoxy group of about 2 to about 5 carbons in length. The alkoxy group may be unfluorinated or partially fluorinated, however, it is preferred in some embodiments herein that the alkoxy group is not fluorinated. Optionally an at least partially fluorinated alkene may be used in the main chain (R_{af})(R_{b})_{y} and/or an alkenoxy group may be provided to (R_{af})(R_{b})_{y} in the O—R_{c} group, however, in some embodiments herein unsaturated bonds are not preferred to avoid potential reactive interference with functional groups involved in the curing of the curable fluoropolymer in the composition.

The at least partially fluorinated organic compounds within the fluid plasticizer which act in the manner of a plasticizer in the compositions herein for fluoroelastomers formed therefrom including those noted above in formula (A), are preferably provided as a fluid plasticizer having a liquid density of about 1.4 to about 2.0 g/ml, and a broad liquid use range from about −150° C., as a low freezing point, to about 275° C., as a boiling point. Further such fluid plasticizers preferably have an absolute viscosity of from about 0.40 cP to about 4.7 cP, and preferably from about 0.6 cP to about 2.0 cP. The molecular weight of such materials may vary depending on the at least partially fluorinated organic compound in the fluid plasticizer, but the fluorinated compound preferably has an atomic molecular weight on average of about 150 g/mol to about 600 g/mol, and more preferably from about 200 g/mol to about 540 g/mol.

It is preferred herein that the fluid plasticizer at least partially, substantially or completely permeates the curable fluoropolymer and infiltrates the polymer structure, and upon curing or heat forming, the plasticizer fluid may be substantially or completely baked out of the formed article.

Additional functional groups to facilitate penetration of the fluid in the curable fluoropolymer are optional, but can be incorporated in the at least partially fluorinated organic compound structure if desired for adjustment of end properties in finished products, e.g., for increasing consistency in blending or for compatibilizing a blended material using standard functionalization techniques as are known or to be developed in the curing, blending and/or compatibilizing arts.

Examples of suitable fluorinated organic compounds for use in the fluid plasticizers herein are specialty fluids and engineered liquid heating fluids that are at least partially fluorinated organic compounds including methoxydecafluoroheptane and its isomers; ethoxy-nonafluorobutene ether and ethoxy-nonafluoroisobutyl ether isomers; ethoxy-trifluoromethylhexanes including 3-ethoxy-1,1,1,2,3,4,5,5,6,6,6-dodecafluoromethylhexane, and similar compounds, and mixtures and combinations thereof.

Fluids including suitable fluorinated organic compounds herein that are commercially available and useful in the compositions and methods herein, include and are available from, for example, Minnesota, Mining and Manufacturing Corporation as 3M™ Heat Transfer Fluids, including Novec™ 700, 7100, 7200, 7300, 7500 and 7700 as well as 649 and 774, with preferred materials being Novec™ 7200, 7300, 7500 and 7700 and including Fluorinert™ FC-3284, FC-72, FC-77, FC-84, FC-770, FC-3283, FC-40, FC-43 with FC-84, FC-770 and FC-3283 being preferred. Others are available from Solvay Corporation as Galden® HT Heat Transfer Fluids HT270, HT230, HT200, HT 170, HT135, HT110, HT80, HT70 and HT55, with HT55 to HT135 being preferred. Also available and useful herein are Opteon™ and Vertrel™ from Chemours, with Opteon™ SF-10 being preferred.

The fluid plasticizers including one or more of the at least partially fluorinated fluid organic compounds herein may be provided to the compositions described, either with a curable fluorinated polymer and any additives before cure of the curable polymer, during or after cure of the curable fluoropolymer, i.e., they may be added to an at least partially, substantially or fully cured fluoroelastomer as well by immersion or soaking of the cured fluoroelastomer. Addition of the fluid plasticizer prior to or during curing provides the benefit of improved processability. However, other benefits of the invention as mentioned herein may be achieved both before, during and/or after curing the curable fluorinated polymer.

The fluid plasticizer having the at least partially fluorinated organic compounds are preferably added to compositions herein such that the at least partially fluorinated organic compound(s) are about 1 to about 20 parts by weight, and preferably about 3 to about 15 parts by weight, per 100 parts by weight of the curable fluoropolymer or fluoroelastomer after at least partial curing. In either case, as the uncured or cured fluoroelastomer is formed and/or subjected to heat molding or other heat processing, the at least partially fluorinated organic compounds are preferably those that may be baked out during or after processing leaving the elastomeric article.

The compositions described herein include one or more curable fluorinated polymer(s), which may be one or more at least partially fluorinated curable polymer(s) including partially fluorinated fluoropolymer(s), and fully fluorinated perfluoropolymer(s). Such materials may be cured using one or more of various curatives as described further below to form cured fluoroelastomeric, including perfluoroelastomeric, materials and articles, or such curative(s) may be omitted from the compositions herein if the curable polymer is curable by radiation.

Initially, in a composition herein, the curable fluoropolymer, such as a curable perfluoropolymer, is in an uncured state. The fluid plasticizer is preferably incorporated into the uncured polymer before the onset of or prior to any substantial crosslinking of the polymer to better incorporate the plasticizer in the polymeric matrix. If the intended end application for the resulting elastomer is one in which rheological properties such as material flow is important, for example, three-dimensional printing, it is preferred to integrate the plasticizer into the uncured polymer prior to crosslinking. It is also important in such end applications to integrate the plasticizer into the at least partially fluorinated polymer prior to subjecting it to a flow process such as prior to any three-dimensional printing.

The curable fluoropolymer(s) herein may be any suitable curable fluoropolymer, including compositions which, when cured, may be used in harsh environments such as those encountered in oilfield industrial use, petrochemical processing, or semiconductor manufacturing, medical, electronics, and other end uses, including such as those used in clean environments and/or may also include those used in forming coatings or other elastomeric articles.

Elastomeric materials (e.g., the cured or crosslinked fluoropolymers herein), are elastomeric as they are able to be compressed and substantially retain their original shape. As used herein, “compression set” refers to the propensity of an elastomeric material to remain distorted and not return to its original shape after a deforming compressive load has been removed. The compression set value is expressed as a percentage of the original deflection that the material fails to recover. For example, a compression set value of 0% indicates that a material completely returns to its original shape after removal of a deforming compressive load. Conversely, a compression set value of 100% indicates that a material does not recover at all from an applied deforming compressive load. A compression set value of 30% signifies that 70% of the original deflection has been recovered. Higher compression set values generally indicate a potential for seal leakage.

Curable fluoropolymers used herein may differ in the degree of fluorination. The curable fluoropolymers may be radiation crosslinkable, but are preferably crosslinkable (curable) through a cure system wherein a curing agent(s) is/are added that is/are capable of reacting with a functional group(s) in the cure site monomer for forming an elastomeric material.

Curable fluoropolymer materials in embodiments herein includes those classified by the Standard Rubber Nomenclature definitions provided by ASTM International in ASTM Standard D1418-22. This includes FKM, FFKM, FEPM and FVMQ curable polymers.

Standard FKM and FEPM polymers in accordance with such elastomer nomenclature typically have at least two monomers, one of which is fluorinated, and in the case of FKMs, preferably all of the monomers are fluorinated to some degree. Such polymers also preferably have at least one cure site monomer for use in vulcanization.

For FEPM polymers, at least one monomer is a fluorinated olefin(s), such as tetrafluoroethylene, and the other monomer(s) is at least one non-fluorinated olefin(s), such as propylene having a reactive hydrogen-containing group as a reactive group on the polymer such that the propylene may be a cure site monomer. Such materials are available commercially, e.g., as Aflas® from Asahi Glass.

In most FKMs, the at least two co-monomers that form the polymer chain preferably include vinylidene fluoride and hexafluoropropylene or a similar fluorinated olefin, but either may include a variety of other monomers as well that are known or to be developed in the art. The fluoroelastomer compositions may also include at least one curing agent that is capable of undergoing a crosslinking reaction with a functional group in the cure site or co-monomer(s) of the curable fluoropolymer used to form the fluoroelastomer.

With respect to the FKM and FEPM materials herein, the polymers may include one or more cure site monomer(s) or may include only one cure site monomer. If there is more than one cure site monomer, there may each have the same or a different cure site. The terms “uncured” or “curable,” refer to fluoropolymers for use in compositions herein, which have not yet been subjected to crosslinking reactions in any substantial degree such that the material is not yet sufficiently cured for the intended end application.

Each cure site is curable by a curative (also known as a crosslinking agent or curing agent). Such cure site monomer(s) may, for example, include a functional group comprising a halogenated material, such as Br or I in a cure site functional group which may be cured using a peroxide curing system. By a “peroxide curing system,” it is meant that a peroxide curative and any associated co-curative which act to form crosslinks that cure the curable polymer to form an elastomer or vulcanizate. Such systems are known in the art.

While at least two of the monomers in an FKM may be hexafluoropropylene (HFP) and vinylidene fluoride (VF2), other typical monomers may be used in addition to these two for forming a variety of fluoropolymers known in the art, and the cure site monomer and cure system may vary.

Optionally, there may be, in addition to the at least one curing agent, if indicated, a co-curing agent, and/or a cure accelerator(s) in compositions including such curable fluoropolymers. The compositions herein may have a single curable fluoropolymer or a combination of at least two curable fluoropolymers, in the form of, for example, a polymer blend, grafted composition or alloy, depending on desired end properties. The curable fluoropolymer for use in the compositions herein may optionally include additional such polymers in blend-like compositions or grafted/copolymerized compositions. Further, the polymer backbones may include a various types of cure site monomer(s) along the chain to provide one or more different functional groups for crosslinking. In embodiments herein, one of such groups may be curable, e.g., by a curative such as a peroxide curing system or a nitrile-containing curative. The compositions may also include curing agents and co-curing agents and/or accelerators to assist in the cross-linking reactions as would be used for curing such fluoroelastomers in the art.

Other cure sites and curing systems may be provided to the same or a different cure site monomer. For example cure sites may be provided that react with a bisphenyl-based curing system for creating cross-linking, such as cure sites which have a nitrogen-containing reactive group may also be used. Such cure sites may be single cure sites on the curable polymer, or a curable polymer may also or alternatively have peroxide curable functional groups such as the halogen-functional cure sites noted above.

A variety of curatives (also referred to herein as crosslinking agents or curing agents), are mentioned herein, and may be used with different variations of curable fluoropolymers depending on their reactive cure site(s) as is known in the art.

A fluoroelastomer composition as described herein may include any suitable standard curable fluoroelastomeric fluoropolymer(s) (FKM) capable of being cured to form a fluoroelastomer, preferably using a cure system and one or more other curing agents as described herein. Examples of suitable curable FKM fluoropolymers include those sold under the trade name Tecnoflon® PL958 available from Solvay Solexis, S.p.A., Italy or other similar fluoropolymers which, when employed in the compositions herein, preferably are curable by a peroxide cure system. Other suppliers of such materials include Daikin Industries, Japan; 3M Corporation, Minnesota; and E.I. DuPont de Nemours & Company, Inc., Delaware, among others. Such FKM polymers are not fully fluorinated on the backbone of the polymer.

One or more curable fluoropolymer(s) may be present in such compositions. Such polymers are themselves formed by polymerizing or co-polymerizing one or more fluorinated monomers. Various techniques known in the art (direct polymerization, emulsion polymerization and/or free radical initiated polymerization, latex polymerization, etc.) can be used to form such polymers. Each such curable fluoropolymer(s) if used in blended or combined form, may have the same cure sites thereon, or different cure site(s) thereon. If different cure sites on different polymers in a blend are used, curing agents that react to cure such cure sites should be selected to crosslink the curable fluoropolymer(s) for crosslinking the polymer(s) used.

The fluoropolymers herein may be formed by polymerizing two or more monomers, one of which is at least partially fluorinated, although all or some of the monomers may be fully fluorinated (perfluorinated) monomers as well. For example, hexafluoropropylene (HFP) and vinylidene fluoride (VF2) may be combined with tetrafluoroethylene (TFE) or one or more perfluoroalkyl vinyl ethers (PAVE), or similar monomers along with at least one monomer which is a cure site monomer to permit curing, i.e. at least one fluoropolymeric cure site monomer.

In preferred embodiments herein, particularly for end applications which require performance in harsh environments such as chemical or plasma environments, downhole environments and clean manufacturing, the at least one curable fluoropolymer is a curable perfluoropolymer that will be useful for forming a perfluoroelastomer. A composition herein, whether a curable fluoropolymer composition or perfluoropolymer composition may include only one fluoro- or perfluoropolymer or may include two or more such fluoro- or perfluoropolymers in the composition which when used and/or cured to would form either a single fluoro- or perfluoroelastomer, or when two or more are used, would form a perfluoroelastomeric blended composition. Further curable fluoropolymers may be blended with curable perfluoropolymers to make partially fluorinated blended fluoroelastomers.

As used in this application, “perfluoroelastomer” or “cured perfluoroelastomer” unless otherwise indicated, includes any cured fluoroelastomeric material or composition that is formed by curing a curable fluoropolymer that is a curable perfluoropolymer such as preferred curable perfluoropolymers in the curable compositions as described further herein.

A “curable perfluoropolymer” (sometimes referred to in the art as a “perfluoroelastomer” or more appropriately a “perfluoroelastomer gum”) that is suitable to be used to form a cured perfluoroelastomer is a polymer that is substantially completely fluorinated, and which is preferably completely perfluorinated, on its polymeric backbone. It will be understood, based on this disclosure, that some residual hydrogen may be present in some perfluoroelastomers within the crosslinks of those materials due to use of hydrogen as part of a functional crosslinking group. Cured materials, such as perfluoroelastomers are cross-linked polymeric structures.

Two or more curable fluoro- or perfluoropolymers, and preferably at least one optional curative (curing agent), may be combined herein in a composition that is then cured forming the resulting crosslinked, cured fluoroelastomeric compositions, and preferably perfluoroelastomeric compositions as described herein.

As used herein, when the curable fluorine-containing elastomeric compositions are curable perfluoropolymer compositions, as with FKMS, curable perfluoropolymers may be blended and combined compositions formed from two or more such curable polymers. The curable perfluoropolymers that are used in perfluoroelastomeric compositions herein to form cured perfluoroelastomers upon cure are formed by polymerizing one or more perfluorinated monomers, and more preferably two or more perfluorinated monomers. One of such perfluorinated monomers is preferably a perfluorinated cure site monomer having a cure site, as noted above, i.e., a functional group to permit curing. The functional group may either be or may include a reactive group that may or may not be perfluorinated, if not fully fluorinated, it is preferred that such reactive groups are on a portion of the polymer that is not on the polymer backbone.

Such curable perfluoropolymer materials are also referred to generally as FFKMs in accordance with the American Standardized Testing Methods (ASTM) standardized rubber definitions and as described above herein in ASTM Standard D1418-22, incorporated herein by reference in relevant part.

As described herein, the invention includes compositions including a curable fluorine-containing polymer, and such fluorine-containing polymer which may be a curable perfluoroelastomer. The invention also includes cured compositions herein and molded or otherwise formed articles formed from such compositions, wherein the compositions have improved processability and a lower glass transition temperature for low temperature end applications due to inclusion of the plasticizers herein.

When curable perfluoropolymers are using the compositions herein, preferably there is at least one, but may be two or more curable perfluoropolymers, preferably perfluoro-copolymers. With respect to the curable perfluoropolymers, at least one monomer is preferably TFE which may be present in varying quantities. In a blend of two or more curable perfluoropolymers, one perfluoropolymer may have a higher content of tetrafluoroethylene (TFE) in comparison to the other.

In addition to TFE, other suitable co-monomers in the perfluorinated polymers may include other ethylenically unsaturated fluoromonomers, such as HFP or other perfluorinated olefin monomers and/or one or more perfluoroalkylvinyl ethers (PAVEs), which include alkyl or alkoxy groups that may be straight or branched and which may also include ether linkages, wherein preferred PAVEs for use herein include, for example, included perfluoromethylvinyl ether (PMVE), perfluoroethylvinyl ether (PEVE), perfluoropropylvinyl ether (PPVE), perfluoromethoxyvinyl ether and other similar compounds, with especially preferred PAVEs being PMVE, PEVE and PPVE. The PAVEs may be used alone or in combinations of the above-noted PAVE types within the curable perfluoropolymers.

Suitable and preferred perfluoropolymers are co-polymers of TFE, at least one PAVE, and at least one perfluorinated cure site monomer that incorporates a cure site or functional group to permit crosslinking of the curable polymer.

Cure site monomers in such curable perfluoropolymers may be of a variety of types as noted herein. Preferred cure sites may include those having nitrogen-containing groups, carboxyl groups, alkylcarbonyl groups, or halogenated groups having, e.g., iodine or bromine as well as other cure sites as are known in the art which may also be used. More than one cure site monomer may be present on a given curable perfluoropolymer. In blends of different perfluoropolymers, each may have the same or may have different cure site monomers.

The disclosure herein provides fluoropolymers, including perfluoropolymers, that are capable of being cured by radiation or that are curable by using one or more of a variety of preferred curatives (also referred to herein as crosslinking agents, curing agents) which are capable of curing cure sites provided on the curable fluoropolymer(s) and/or perfluoropolymer(s) herein.

Exemplary cure site monomers are listed below for use in the curable fluoropolymer(s) or curable perfluoropolymer(s) described herein for use in the compositions herein, most of which are PAVE-based in structure and have a reactive site. Such monomers are examples only and not intended to be limiting. Although the polymers may vary, examples of structures that may be used include those having the following structure (A):

CF₂=CFO(CF₂CF(CF₃)O)ₘ(CF₂)ₙ-X¹ (A)

wherein m may be 0, or m and n may be varied integers from 1 to 5. X¹ may be a nitrogen-containing group, such as nitrile or cyano. However, carboxyl groups, alkoxycarbonyl groups or halogenated end groups may also be used as X¹.

Compounds according to formula (A) may be used alone or in various, optional, combinations thereof.

Further examples of cure site monomers according to formula (A) include formulas (1) through (17) below:

CY₂=CY(CF₂)ₙX²(1)

wherein Y is H or F, n is an integer from 1 to about 8

CF₂=CFCF₂Rf²-X² (2)

wherein Rf² is (—CF₂)ₙ—, —(OCF₂)ₙ— and n is 0 or an integer from 1 to about 5

CF₂=CFCF₂(OCF(CF₃)CF₂)ₘ(OCH₂CF₂CF₂)ₙOCH₂CF₂-X² (3)

wherein m is 0 or an integer from 1 to about 5 and n is 0 or an integer of from 1 to about 5

CF₂=CFCF₂(OCH₂CF₂CF₂)ₘ(OCF(CF₃)CF₂)ₙOCF(CF₂)-X² (4)

wherein m is 0 or an integer from 1 to about 5, and n is 0 or an integer of from 1 to about 5

CF₂=CF(OCF₂CF(CF₃))ₘO(CF₂)ₙ-X² (5)

wherein m is 0 or an integer from 1 to about 5, and n is an integer of from 1 to about 8

CF₂=CF(OCF₂CF(CF₃))ₘ-X²(6)

wherein m is an integer from 1 to about 5

CF₂=CFOCF₂(CF(CF₃)OCF₂)ₙCF(-X²)CF₃ (7)

wherein n is an integer from 1 to about 4

CF₂=CFO(CF₂)ₙOCF(CF₃)-X² (8)

wherein n is an integer of from 2 to about 5

CF₂=CFO(CF₂)ₙ-(C₆H₄)-X²(9)

wherein n is an integer from 1 to about 6

CF₂=CF(OCF₂CF(CF₃))ₙOCF₂CF(CF₃)-X² (10)

wherein n is an integer from 1 to about 2

CH₂=CFCF₂O(CF(CF₃)CF₂O)ₙCF(CF₃)-X² (11)

wherein n is 0 or an integer from 1 to about 5

CF₂=CFO(CF₂CF(CF₃)O)ₘ(CF₂)ₙ=X² (12)

wherein m is 0 or an integer from 1 to about 4 and n is an integer of 1 to about 5

CH₂=CFCF₂OCF(CF₃)OCF(CF₃)-X² (13)

CH₂=CFCF₂OCH₂CF₂-X² (14)

CF₂=CFO(CF₂CF(CF₃)O)ₘCF₂CF(CF₃)-X² (15)

wherein m is an integer greater than 0

CF₂=CFOCF(CF₃)CF₂O(CF₂)ₙ-X² (16)

wherein n is an integer that is at least 1

CF₂=CFOCF₂OCF₂CF(CF₃))OCF₂-X² (17)

wherein X² can be a monomer reactive site subunit such as a nitrile (—CN), carboxyl (—COOH), an alkoxycarbonyl group (—COOR, wherein R is an alkyl group of 1 to about 10 carbon atoms which may be fluorinated or perfluorinated), a halogen or alkylated halogen group (I or Br, CH₂I and the like).

In curable perfluoropolymers for use in compositions herein, TFE as a co-monomer may be present in a molar percentage in the perfluoropolymer compound in an amount of about 40 about 95 mole percent. Other co-monomers, such as perfluorinated PAVE monomer, many of which are known in the art and may be used herein. A variety of PAVEs as noted above may be used in the curable polymer for use in the compositions herein, and may be incorporated in a molar percentage in the perfluoropolymer compound in an amount of about 5 mole percent to about 60 mole percent with TFE. Each of the cure site monomer(s) may be present in an amount of from about 0.1 mole percent to about 6 mole percent, although if more than one is used, they may be present collectively in amounts up to about 10 mole percent in total. Optionally, each cure site monomer may be present in amounts of about 0.2 to 5.0 mole percent or 0.5 to about 2.0 mole percent.

Suitable perfluoropolymers are commercially available from Daikin Industries, Ltd. and are described in U.S. Pat. Nos. 6,518,366 and 6,878,778 and U.S. Published Patent Application No. 2008-0287627, which are each incorporated herein in relevant part with respect to the perfluoropolymers described therein. Additional perfluoropolymers for use in preferred embodiments herein are those including at least two cure site monomers as described in International Publication No. WO 00/29479 A1, incorporated herein in relevant part with respect to such perfluoroelastomers, as well as commercial perfluoroelastomers known as PFK-65 or PFK-100.

In some embodiments herein, there may be two curable fluoropolymers in a blend in which a polymer such as those noted above may be used with a second curable fluoropolymer or curable perfluoropolymer used herein that may be the same or different than that noted above, and such second curable polymer may have, but need not have, the same content of TFE or PAVE.

In one embodiment, a perfluoropolymer may be used in which a fluoroplastic material is incorporated therein such as a fluoroplastic. The fluoroplastic particles may be provided in a variety of forms and using a variety of techniques. Fluoroplastics such as PTFE, and co-polymers thereof (FEP and PFA type polymers), core-shell or other modified fluoropolymers and in a variety of sizes (microparticles, nanoparticles and the like), each of which alone or in combination may be incorporated into the material by mechanical means or chemical processing and/or polymerization. Techniques which are known or to be developed may be employed, such as those described in U.S. Pat. Nos. 4,713,418 and 7,476,711 (each of which is incorporated herein by reference with respect to such technology) and other techniques as described in U.S. Pat. No. 7,019,083, also incorporated herein by reference with respect to use of fluoroplastic particles. Suitable commercially available polymers are commercially available from 3M Corporation of St. Paul, Minnesota.

Examples of other perfluoropolymers and resulting elastomers formed therefrom using cure site monomers such as those noted above may be found in U.S. Pat. Nos. 6,518,366, 6,878,778 and U.S. Published Patent Application No. 2008-0287627 as well as U.S. Pat. No. 7,019,083, each is incorporated herein in relevant part with respect to the perfluoropolymers described therein and their resulting elastomers and methods of forming the same.

Uncured perfluoropolymers may also be obtained commercially under the name Dyneon™ by 3M Corporation, St. Paul, Minnesota, Daiel-Perfluor® and other similar polymers, available from Daikin Industries, Ltd. of Osaka, Japan. Other preferred materials are available also from Solvay Solexis in Italy, Asahi Glass, Japan, and W. L. Gore. Other examples of suitable perfluoropolymers and blends thereof may be found, for example in U.S. Pat. Nos. 9,018,309 and 9,365,712, incorporated herein by reference with respect to suitable perfluoropolymers, and blends thereof.

Perfluoropolymers for use in the compositions claimed herein may be synthesized using any known or to be developed polymerization technique for forming fluorine-containing elastomers using polymerization, including, for example, emulsion polymerization, latex polymerization, chain-initiated polymerization, batch polymerization and others. Preferably, the polymerization is undertaken so that reactive cure sites are located either on either or both terminal ends of the polymer backbone and/or are depending from the main polymer backbone.

While uncured perfluoropolymers may be cured through any method, including use of radiation curing, it is preferred to include at least one curative (also referred to herein as crosslinking agents, curing agents and/or curing systems) for use with various curable fluorine-containing curable fluoropolymer and perfluoropolymers in the compositions herein which may be selected for use with various cure sites described herein and should be capable of curing (i.e., capable of reacting and crosslinking) or otherwise undergoing a curing reaction with the cure sites or functional groups of the cure site monomer(s) of the various uncured perfluoropolymers in the compositions to form crosslinks, resulting in an elastomeric material which may be in the form of a molded or printed article.

Suitable crosslinking or curing agents are those that form crosslinks that have oxazole, thiazole, imidazole, or a triazine rings. Such compounds as well as other curatives including amidoximes, tetraamines and amidrazones may be used for cross-linking in the present invention.

For nitrogen-containing cure sites, preferred curatives are bisphenyl-based curatives and derivatives thereof, including bisaminophenol and its salts and combinations thereof; bisaminothiophenols, parabenzoquinone dioxime (PBQD), as well as salts of various such compounds may be used. Examples of suitable curatives may be found, for example, in U.S. Pat. Nos. 7,521,510 B2, 7,247,749 B2 and 7,514,506 B2, each of which is incorporated herein in relevant part with respect to the listing of various curatives for cyano-group containing perfluoropolymers. In addition, the perfluoropolymers may be cured using radiation-curing technology.

Further preferred curatives for cure sites having a cyano-group cure site are curatives having aromatic amines with at least two crosslinkable groups as in formulas (I) and (II) below, or a combination thereof, which form benzimidazole cross-linking structures upon cure. These curatives are known in the art and discussed in relevant part and with specific examples in U.S. Pat. Nos. 6,878,778 and 6,855,774, which are incorporated herein in their entirety.

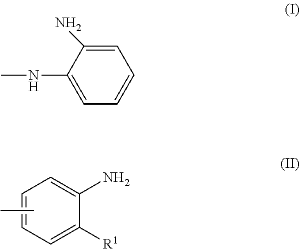

wherein R¹ is the same or different in each group according to formula (II) and may be NH₂, NHR², OH, SH or a monovalent organic group or other organic group such as alkyl, alkoxy, aryl, aryloxy, aralkyl and aralkyloxy of from about 1 to about 10 carbon atoms, wherein the non-aryl type groups may be branched or straight chain and substituted or unsubstituted and R² may be —NH₂, —OH, —SH or a monovalent or other organic group such as an aliphatic hydrocarbon group, a phenyl group and a benzyl group, or alkyl, alkoxy, aryl, aryloxy, aralkyl and aralkyloxy groups, wherein each group is from about 1 to about 10 carbon atoms, wherein the non-aryl type groups may be branched or straight chain and substituted or unsubstituted. Suitable monovalent or other organic groups, such as alkyl and alkoxy (or perfluorinated versions thereof) may be from 1 to 6 carbon atoms, and examples of suitable aryl type groups include phenyl and benzyl groups. Examples thereof include —CF₃, —C₂F₅, —CH₂F, —CH₂CF₃ or —CH₂C₂F₅, a phenyl group, a benzyl group; or a phenyl or benzyl group wherein 1 to about 5 of the hydrogen atoms are substituted by fluorine atoms such as —C₆F₅, —CH₂C₆F₅, wherein groups may be further substituted, including with —CF₃ or other lower perfluoroalkyl groups, or, phenyl or benzyl groups in which 1 to 5 hydrogen atoms are substituted by CF₃ such as for example C₆H₅₋ₙ(CF₃)ₙ, —CH₂C₆H₅₋ₙ(CF₃)ₙ (wherein n is from 1 to about 5). Hydrogen atoms may be further substituted with phenyl or benzyl groups.

A structure having formula (I) or (II) incorporated in an organic amine should include at least two such groups of formula (I) or (II) such that at least two cross-linking reactive groups are provided. Also useful herein are curatives having formulas (III), (IV) and (V) shown below.

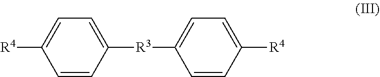

wherein R³ is may be SO, O or CO or an organic or alkylene type group, such as an alkyl, alkoxy, aryl, aralkyl or aralkoxy group of from one to six carbon atoms or perfluorinated versions of such groups, having from about one to about 10 carbon atoms, and being branched or straight chain, saturated or unsaturated, and branched or straight chain (with respect to the non-aryl type groups) or a single bond. R⁴ is a reactive side group such as those set forth below:

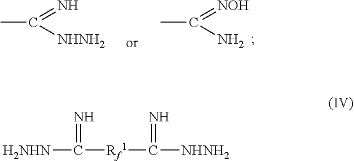

wherein Rf¹ is a perfluoroalkyl or perfluoroalkoxy group of from about 1 to about 10 carbon atoms that may be a straight or branched chain group and/or saturated or unsaturated and/or substituted or unsubstituted; and

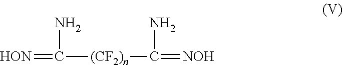

wherein n is an integer of about 1 to about 10.

Single curatives or combinations thereof may be chosen from all of the curatives herein within the scope of the invention depending on the cure sites to be crosslinked. With respect to good heat resistance, oxazole-, imidazole-, thiazole- and triazine-ring forming crosslinking agents are useful and can include the formula compounds listed below and discussed further below with respect to Formulae (I), (II), (III), (IV) and (V), specifically, formula (II) wherein R is the same or different and each is —NH₂, —NHR², —OH or —SH, wherein R² is a monovalent organic group, preferably not hydrogen; formula (III) wherein R is —SO₂—, —O—, —CO—, and alkylene group of 1 to about 6 carbon atoms, a perfluoroalkylene group of 1 to about 10 carbon atoms or a single bond and R⁴ is as noted below; formula (IV) wherein Rf¹ is a perfluoroalkylene group of 1 to about 10 carbon atoms, and formula (V) wherein n is an integer of 1 to about 10.

Exemplary curatives based on the above preferred formulae include at least two functional groups, such as the following structures formula (VI), (VII) or (VIII):

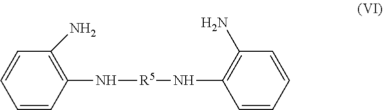

wherein R⁵ represents a saturated or unsaturated, branched or straight chain, substituted or unsubstituted group such as alkyl, alkoxy, aryl, SO, O, CO, or similar groups which are perfluorinated with respect to the carbon atoms and which is preferably about 1 to about 10 carbon atoms;

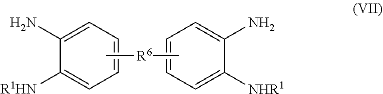

wherein R¹ is as defined elsewhere herein and R⁶ may be O, SO₂, CO or an organic group which may be perfluorinated, such as alkyl, alkoxy, aryl, aryloxy, aralkyl and aralkyloxy of from about 1 to about 10 carbon atoms, wherein the non-aryl type groups may be branched or straight chain and substituted or unsubstituted, or a single or alkylene bond.

In one embodiment herein, a compound can be used including at least two chemical groups with cross-linking reactive groups as in Formula (I) or (II) in order to increase heat resistance and to stabilize an aromatic ring system. For groups such as in (I) or (II), having two to three such groups, it is preferred to have at least two in each group (I) or (II), as having a lesser number of groups may not provide adequate cross-linking. Such combinations are known and are described in U.S. Pat. Nos. 9,018,309 B2 and 9,365,712 B2, incorporated herein in relevant part.

Other crosslinking agents include compounds having two crosslinkable reactive groups as represented by formula (II) are shown below in formula (VIII).

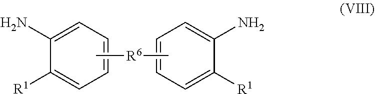

wherein R¹ is as above and R⁶ is —SO₂, —O—, —CO—, an alkylene group of 1 to about 6 carbon atoms, a perfluoroalkylene group of 1 to about 10 carbon atoms, a single bond or a group as shown in Formula (IX):

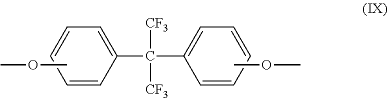

wherein this formula may provide easier synthesis in some instances. Examples of alkylene groups of from 1 to about 6 carbon atoms are methylene, ethylene, propylene, butylene, pentylene, hexylene and the like. Examples of perfluoroalkylene groups of 1 to about 10 carbon atoms are

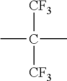

and the like. These compounds are known as examples of bisaminophenyl compounds. Preferred compounds according to this structure include those of formula (X):

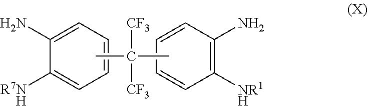

wherein R⁷ is the same or different in each instance and each R⁷ is hydrogen, an alkyl group of 1 to about 10 carbon atoms; a partially fluorinated or perfluorinated alkyl group of 1 to 10 carbon atoms; a phenyl group; a benzyl group; or a phenyl or benzyl group in which 1 to about 5 hydrogen atoms have been replaced by fluorine or a lower alkyl or perfluoroalkyl group such as CF₃.

Non-limited examples of curatives include 2,2-bis(2,4-diaminophenylhexafluoropropane, 2,2-bis[3-amino-4-(N-methylamino)phenyl]hexafluoropropane, 2,2-bis[3-amino-4-(N-ethylamino)phenyl] hexafluoropropane, 2,2-bis[3-amino-4-(N-propylamino)phenyl] hexafluoropropane, 2,2-bis[3-amino-4-(N-phenylamino)phenyl]hexafluoropropane, 2,2-bis[3-amino-4-(N-perfluorophenylamino)phenyl]hexafluoropropane, 2,2-bis[3-amino-4(N-benzylamino)phenyl]hexafluoropropane, and similar compounds. Of these, for preferred excellent heat resistance properties, 2,2-bis[3-amino-4(N-methylamino)phenyl]hexafluoropropane, 2,2-bis[3-amino-4-(N-ethylamino)phenyl]hexafluoropropane, 2,2-bis[3-amino-4-(N-propylamino)phenyl]hexafluoropropane and 2,2-bis[3-amino-4-(N-phenylamino)phenyl]hexafluoropropane are preferred. Also preferred for heat resistant properties is tetra-amines such as 4,4′-[2,2,2-Trifluoro-1-(trifluoromethyl) ethylidene]bis[N1-phenyl-1,2-benzenediamine] or 2,2-bis[3-amino-4-(N-phenylaminophenyl)]hexafluoropropane is preferred.

Other suitable curatives include oxazole-, imidazole-, thiazole-, and triazine-ring forming curatives, amidoxime and amidrazone crosslinking agents, and particularly bisaminophenol, bisaminophenol AF, and combinations thereof; bisaminothiophenols; bisamidines; bisamidoximes; bisamidrazones; monoamidines; monoamidoximes and monoamidrazones as known in the art or to be developed, examples of which are set forth, for example in U.S. Pat. Nos. 7,247,749 and 7,521,510, incorporated herein in relevant part by reference, including the curatives and co-curatives and accelerators therein. In some embodiments herein, bisamidoxime, bisamidrazone, bisaminophenol, bisaminothiophenol or bisdiaminophenyl curatives are suitable when reacting with nitrile or cyano groups, carboxyl groups, and/or alkoxycarbonyl groups in the perfluoropolymer to form a perfluoroelastomer having an oxazole ring, a thiazole ring, an imidazole ring, or a triazine ring as crosslinks in the resulting cured articles formed from the compositions herein.

If more than one cure site monomer is used, each monomer in each of the curable perfluoropolymers is preferably present in an amount of about 0.1 to about 10 mole percent.

When at least one curative is used, it may be present in varying amounts suitable to cure the curable perfluoropolymers' cure site monomers in the composition, for example, in total amounts of about 0.2 parts by weight to about 10 parts by weight per 100 parts by weight of the perfluoropolymers in the composition, and each may be present in an amount of about 0.1 to about 6 parts by weight per 100 parts by weight of the perfluoropolymers in the composition, or preferably about 0.1 to about 2 parts by weight per 100 parts by weight of the perfluoropolymers in the composition.

The at one cure site in the at least one cure site monomer in the perfluoropolymer(s) may be a nitrogen-containing cure site, a peroxide-curable cure site or cure sites that are able to form triazine rings. Peroxide curatives and co-curatives as are well known in the art may also be used if halogenated cure sites are employed. Other suitable curatives may include those listed above.

With respect to curable at least partially or fully fluorinated silicon-containing polymers, thermoset silicon-containing polymers that are at least partially fluorinated may be used and include a variety of at least partially fluorinated silicon-containing homopolymers and co-polymers that are curable to form a fluorosilicone (which is an elastomer and also referred to as a fluorosilicone rubber or a fluorinated silicone rubber). Curable, at least partially fluorinated silicones are generally polymers that incorporate at least silicon, fluorine, and may also include oxygen and/or hydrogen in their chemical structure. Curable thermoset fluorinated silicon-containing polymers which may be used to form fluorosilicones (elastomers) include polymers having a backbone as classified by the Standard Rubber Nomenclature definitions provided by ASTM International in ASTM D1418-17 as FVMQ (fluorosilicones). However, fluorinated silicones that are not readily classified by ASTM D1418-22 may also be used provided they demonstrate useful additive manufacturing printable characteristics as described herein.

“Curing” with respect to fluorinated silicon-containing polymers as used herein is meant to encompass any method of providing the requisite elastomeric silicone structure by vulcanization, chemical crosslinking, catalyzed cross-linking and the like. After curing, thermoset at least particular fluorinated silicon-containing polymers form fluorosilicone elastomers.

In an uncured state, a silicone is typically a liquid or an adhesive gel. Curable, at least partially fluorinated silicon-containing polymers for forming fluorosilicone rubber can be cured using a variety of curing systems, including catalyst cure systems, typically using a platinum-based catalyst, a condensation curing system, a peroxide cure system and an oxime cure system.

In platinum catalyst curing, crosslinks are formed using functional at least partially fluorinated silicone polymers such as vinyl-functional silicones and hydride-functional silicones through addition reactions to form the crosslinks. Such reaction leaves no byproducts and so is a typical pathway for curing in the art.

Condensation systems typically involve a crosslinking material that is activated in some manner. In a common one-part system, at least partially fluorinated functional silicon-containing polymers are employed that when contacted with water at room temperature will undergo hydrolysis and the hydrolyzable groups (hydroxyl or silanol groups) will initiate the curing reaction. The hydrolysis reaction once initiated continues until curing is done, and can take place at room temperature. Crosslinking materials include, for condensation systems including functional silanes having active oxygen containing groups such as alkoxy, acetoxy, ester, enoxy or oxime silanes, e.g., methyltrimethoxysilane, methyltriacetoxysilane and similar materials, wherein the silanes or other reactants are at least partially fluorinated. Such substituted groups and/or functionalized groups can be catalyzed as well if desired using organometallic catalysts such as tetraalkoxytitanates, chelated titanates, tin catalysts (e.g., dibutyl tin dilaurate and acetoxy tin).

In a two-part condensation, the crosslinking material and any catalyst is retained in one container while the curable silicon-containing polymer composition (absent those materials) is retained in a separate container. The curing is initiated upon mixing of the materials in the two containers.

Other silicone cure systems for forming silicone elastomers include peroxide cure systems that can crosslink through a reactive silicone site forming an Si—R—Si link between silicone chains.

Preferably the curable, at least partially fluorinated silicon-containing polymers used herein are one or more of at least partially fluorinated: polysiloxanes, polyalkylsiloxanes, polydialkylsiloxanes, polyarylsiloxanes, polyaralkylsiloxanes, and blends, alloys or copolymers of these materials with each other. Further, such thermoset, at least partially fluorinated silicon-containing polymers may have one or more hydrogen or one or more silicon-bonded group(s) on the silicon atoms in the main chain substituted with one or more groups, each of which substituted groups may further be functionalized or further substituted, and preferably such groups (or further substituted or functionalized groups thereon) include fluorine. Such substituted or functional groups may be branched and/or straight chain groups, including but not limited to hydroxyl, alkyl, alkenyl, alkynyl, aryl, alkoxy, alkenoxy, alkynoxy, aryloxy, arylalkyl, arylalkoxy, arylalkenoxy, vinyl, carboxyl, carbonyl, halogen, heterocyclic, each of which may be partially fluorinated or perfluorinated, provided that the resulting silicon-containing polymer remains at least partially fluorinated along the primary chain of the polymer and/or in is at least partially fluorinated in one or more branched groups bonded to the primary chain of the polymer.

Compositions including at least on partially fluorinated silicone-containing polymers herein may include curatives, cure initiators, crosslinkers such as a hydrolytic crosslinker, cure catalysts such as an organic peroxide, and other cure system components as noted above and as are known in the art or to be developed. Additives and/or modifiers may further be incorporated into the composition including the at least partially fluorinated silicone-containing polymer(s), and include, but are not limited to, siloxane additives, ultra-high molecular weight siloxane additives, clarifiers, processing aids, stabilizers, thixotropic agents, rheological agents, compatibilizers, colorants such as pigments and dyes, fillers, such as carbon black, quartz, silica, pyrogenic silica, carbon nanotubes, glass fiber and optional coupling agents, aramid fiber, olefinic fibers, carbon fibers, UV absorbers, UV stabilizers, lubricants, such as waxes, fatty acids and other rheological additives, flame retardants, polyols, amides, fluoropolymers, fluorinated or perfluorinated polymer additives, nanosilica (i.e., nanosilicon dioxide) particles, polysiloxanes, antiblocking aids such as silica and talc, optical brighteners, dispersants, wetting agents, compatibilizers and any other suitable additives and/or modifiers for at least partially fluorinated silicon-containing polymers for providing desired composition properties, provided that preferably such additive(s) will be chosen so as not to block, prevent or substantially impede the use of the at least one fluid plasticizer(s) described herein.

Preferred additives for use in a curable, thermoset, at least partially fluorinated silicon-containing polymer composition herein include curatives such as peroxide curatives, typically incorporated in about 0.01 to about 5.5 parts per 100 parts of the curable at least partially fluorinated silicon-containing polymer, or in other systems a platinum catalyst in an amount of about 0.0005 to about 0.005 parts per 100 parts of the curable at least partially fluorinated silicon-containing polymer. Other preferred additives include colorants and pigments such as white (titanium oxide), yellow (iron oxide or azo), blue (phthalocyanine GS or ultramarine), and/or green (phthalocyanine BS) in amounts that may vary but typically individually up to about 1.0 parts per hundred parts of the curable at least partially fluorinated silicon-containing polymer or collectively up to about 1.5 parts per 100 parts of the curable at least partially fluorinated silicon-containing polymer.

Such additives, other than any specific cure system, are optional and may be incorporated in amounts up to a total of about 50% by weight.

Depending on the cure system used, the degree of relevant curative may be adjusted for the system. As such, cure systems are known in the art for FVMQ systems, the same systems may be used herein as noted above. Preferred examples of thermoset fluorosilicones for use within the invention include commercially available silicones such, for example, but not limited to two-part silicones with platinum cure systems, including Silastic™ FSR, such as Silastic™ FL 60-9201 available from Dow Chemical; Momentive™ fluorosilicones FF160 and FF170; Wacker Chemical Corporation, ElastoSil® R 901/40 CN. Such systems may be used and combined as recommended by their manufacturers. Other fluorosilicones that meet similar criteria and capabilities may also be used herein.

Cured fluoroelastomers, perfluoroelastomers, and/or cured fluorosilicones formed from the curable fluoroelastomeric compositions, including perfluoroelastomeric compositions as noted herein may be cured and shaped so as to form a molded article(s) using both well-known techniques for shaping molded articles including sealing members such as O-rings, seals, gaskets, inserts and the like, but other shapes and method of forming known or to be developed in the art are contemplated herein as such compositions allow for processing using previously not preferred methods of processing fluoropolymers and perfluoropolymers, including curable fluoropolymers comprising silicon in view of the improved processability herein.

The compositions herein may be used in additive manufacturing as a composition “ink” for printing articles such as those noted above or other articles of varying types to create a wide variety of useful end products based on pre-programmed designs and using known three-dimensional printing apparatus or specialty designed printing apparatus as described in U.S. Patent Application No. 2021/0395405 A1 of the present applicant herein.

Further, the compositions, due to the enhanced processability provided by the plasticizers herein may be processed using other types of methods not previously considered with traditional FKM/FFKM/FEPM and/or FVMQ processing, including injection molding, extrusion, film-formation, transfer molding and extruded sheets and parts as well as three-dimensionally designed articles for mass production or for small volume designs. Using these types of plasticizers may be employed to make it possible to use transfer molding or injection molding of large parts like an oilfield packing element easier to produce and improve the low temperature properties of the elastomer, e.g., with respect to FKM, FFKM or FEPM. In such a use, if desired, the plasticizer could be removed (such as by baking out) after setting the packer down hole.

The molded articles or heat-formed articles may also be used in oilfield, energy, semiconductor and other end applications where conditions are harsh and high chemical- or plasma-resistance is indicated, e.g., parts formed from the materials may be bonded to a surface for forming, for example, bonded seals. Such bonded seals may be used, for example for forming pre-bonded doors, gates, and slit valve doors for use, e.g., in semiconductor processing and other end use applications. Replacement seals can be re-printed or remolded easily for custom projects or fast turnaround on replacement parts. The surfaces to which such molded articles, such as seals may be bonded include polymeric surfaces as well as metal and metal alloy surfaces. In one embodiment, the invention includes a gate or slit valve door formed of, e.g., stainless steel or aluminum, to which an O-ring seal conforming to a recess in the door configured for receiving the seal. The bonding may occur through use of a bonding composition or through an adhesive.

Other end applications include medical equipment, implant or artificial tissue use, more readily moldable parts for dielectric and other tooling, protective coatings for use on tools, electronics and building materials, integration into QTC composites, or as a base material for use in direct formation of gaskets and other parts for radio frequency interference (RFI) and/or electromagnetic interference (EMI) shielding, seals or parts in aerospace and fluid handling end applications and similar applications for fluoroelastomers, including FKMs, FFKMs, FEPMs and FVMQs. The lowering of the viscosity may also be used to enhance the processability of such materials in three-dimensional printing end application.

The curable elastomer compositions herein are first prepared by combining the at least one curable fluoro- or perfluoropolymer(s) as described elsewhere herein if a blend is used, e.g., a first and a second perfluoropolymer with the plasticizers described herein.

If more than one polymers is used, the polymers may first be combined using typical rubber processing equipment such as an open roll, Banbury mixer, kneader or the like and other additives may also be pre-blended. The compositions may also be prepared using a method of a closed mixer. Preferably a typical mixer, such as a two-rotor mixer as is typically used for combining fluoropolymer(s) and the other materials noted. Preferably, in this method, particularly for perfluoropolymer(s) the polymers are mixed at room temperatures, or at elevated temperatures of about 30° C. to about 100° C., or about 50 to about 250° C., depending on the mixer type and design and the polymer being processed.

Other additives are not required, but may be added if desired to alter certain properties. Examples of such additives include cure accelerators, co-curatives, co-agents, processing aids, other plasticizers, fillers such as silica, fluoropolymers as noted above such as TFE, fluorinated-copolymers, core-shell modified fluoropolymers, and the like in micropowder, pellet, fiber and nanopowder forms, fluorographite, silica, barium sulfate, carbon, carbon black, nanodiamonds, microdiamonds, carbon fluoride, clay, talc, metallic fillers (titanium oxide, aluminum oxide, yttrium oxide, silicon oxide, zirconium oxide), metal carbides (silicon carbide, aluminum carbide), metallic nitrides (silicon nitride, aluminum nitride), other inorganic fillers (aluminum fluoride, carbon fluoride), colorants, organic dyes and/or pigments, such as azo, isoindolenone, quinacridone, diketopyrrolopyrrole, anthraquinone, and the like, imide fillers (such as polyimide, polyamide-imide and polyetherimide), ketone plastics (such as polyarylene ketones like PEEK, PEK and PEKK), polyarylates, polysulfones, polyethersulfones, polyphenylene sulfides, polyoxybenzoate, and the like may be used in amounts known in the art and/or which may be varied for different properties. All of the fillers herein may be used alone or in combinations of two or more such fillers and additives.

In some embodiments herein, any additives as well as any curative(s) capable of curing the cure site(s) on the at least one cure site monomer(s), including any cure accelerators, co-curatives, co-agents and the like are added after the other fillers and/or additives are incorporated into the fluoro- or perfluoropolymer(s) and blended before addition of the novel plasticizers herein.

The compositions herein may be highly filled if desired or formed without fillers or additives, other than the novel fluid plasticizer and any curatives and associated co-curatives and/or accelerators. Optional, additional fillers such as those noted above may be used in a total amount of up to about 95 parts, up to about 100 parts or up to about 150 parts by weight per 100 parts by weight of the combined curable perfluoropolymers in the composition, and may be more or less, particularly if higher levels of fillers are needed.

After the curable fluoro- or perfluoropolymer(s) are combined with the optional additive(s), including any optional curative(s), and, if already added, the fluid plasticizer herein, the curable fluoro- or perfluoropolymer(s) in the elastomeric or perfluoroelastomeric compositions are cured to form a cured fluoroelastomeric or perfluoroelastomeric articles as described herein.

The curable compositions are preferably cured at temperatures and for times which would be traditionally used to form the desired cross-links depending on the curing method or curing system, cure sites and/or curatives chosen. The temperatures should be sufficient to allow the curing reaction to proceed until the curable fluoro- or perfluoropolymer(s) in the composition are substantially cured, preferably at least 90% cured or higher. Preferred curing temperatures and times for preferred curable perfluoropolymer compositions, e.g., are about 150° C. to about 250° C., for about 5 to about 40 minutes. Following curing, optional postcuring steps may be used. Acceptable postcure temperatures and times for most preferred perfluoropolymers noted herein, e.g., are about 200° C. to about 320° C. for about 5 to about 48 hours.

While curing, the curable compositions described herein may be formed into a molded article while simultaneously curing using heat and pressure applied to a mold. The combined curable fluoro- and perfluoropolymer(s) may be formed into a preform, such as an extruded rope or other shape useful for including the preform in a mold having a recess shaped to receive the preform and for forming a molded article while curing. Such compositions may also be cured using other heat processing methods in view of the addition of the fluid plasticizers herein. Optional postcuring and bake out can also be carried out preferably under air or nitrogen or vacuum. Alternatively, the curable compositions may be formed into shaped articles or formed into a three-dimensionally printed articles using other shaping or processing methods.

In end uses, applications and other instances where improved processability is required, such as in additive manufacturing process or in industrial coatings and the like, viscosity may be lowered and processability improved for curable fluorine-containing polymers which, as noted above, are known to have a high viscosity and difficulty in processing, with such materials demonstrating Mooney viscosity (ML 1+10@121° C.) values of about 30 to about 160 or more. Similarly, molded articles formed of such materials such as preforms or parts in molded articles formed from the compositions also experience processability and viscosity issues. To improve processability and reduce viscosity in such materials, the fluorine-containing polymers having such higher Mooney viscosities as noted above may be incorporated therein in a fluorine-containing polymer composition one or more further curable fluorine-containing polymer that has a low Mooney viscosity (ML 1+10@121° C.) of about 10 to about 45. It is preferred that when combining a lower Mooney viscosity curable fluorine-containing polymer into a higher Mooney viscosity polymer, that the second polymer to be added should be selected to have a Mooney viscosity lower than the first polymer used, in order to reduce the Mooney viscosity of the first polymer used. Many fluoroelastomers and perfluoroelastomers and their compounded forms have Mooney viscosities that are reasonably high, so that bringing them to a point where they have improved processability is significant for use in flow-related end applications.

Suitable low or lower Mooney viscosity polymers may be blended, alloyed or copolymerized into the base, high or higher viscosity fluorine-containing polymer using a roll mill and preform extruder as is known in the art. Functionalization of either or both of the polymers to compatibilize or alloy them together, or grafting or otherwise copolymerizing the lower viscosity fluorine-containing polymer with the higher viscosity fluorine-containing polymer may also be carried out using techniques known in the art within the scope of the invention.

The low or lower viscosity curable fluorine-containing polymer may be present in the composition in weight percentage based on 100 parts by weight of the total fluorine-containing polymer(s) of about 5 weight percent to about 95 weight percent, or about 10 weight percent to about 90 weight percent, or about 20 weight percent to about 80 weight percent, or about 25 weight percent to about 75 weight percent or about 40 weight percent to about 60 weight percent, or about 50 weight percent, with each range incorporating within the scope thereof all ranges of integers and fractions of weight percentage values named and within the range. The amount of the lower viscosity curable fluorine-containing polymer can be adjusted depending on the viscosity of the higher curable viscosity polymer, and the intended end use of the composition and in some preferred embodiments is about 10 to about 20 weight percent of the total combined weight of the curable fluorine-containing polymers in the composition.

When using the combined high and low Mooney viscosity fluorine-containing polymers in the composition may in some instances sufficiently improve processability, it is also within the scope of the invention to further introduce to such a composition the at least one fluid plasticizers having the at least one, at least partially fluorinated organic compounds to the composition and/or incorporating further plasticizers different from the fluid plasticizers herein.

The compositions may also include various curatives, curing systems and additives as described above for the curable fluorine-containing polymer compositions herein, and the fluorine-containing polymers in the compositions may be partially or substantially fluorinated or perfluorinated. Such compositions having fluorine-containing polymers of high and low Mooney viscosities in combination and/or further incorporating the fluid plasticizers herein may be used in end applications and uses where processability and lowered viscosity are important and in harsh environments, where fluorinated or perfluorinated materials are used including those uses listed above for prior embodiments and additive manufacturing and coating applications.

The invention will now be described with respect to the following non-limiting Examples:

### Example 1

Three filled and mixed curable perfluoropolymer compositions were prepared herein and mixed with a fluid plasticizer having an at least partially fluorinated organic compound in the form of a commercial product, Novec™ 7500. Control Samples were made from each of the filled and mixed curable perfluoropolymer compositions without the inclusion of the Novec™ 7500. Thus, each Control Sample A, B and C did not include Novec™ 7500. The curable perfluoropolymer in Control Sample A was Tecnoflon™ perfluoropolymer PFR-95HT from Solvay Specialty Polymers. The curable perfluoropolymer in Control Sample B was Dai-el™ Perfluoro GA500 from Daikin Industries, Inc. The curable perfluoropolymer in Control Sample C was Tecnoflon™ PFR LT, from Solvay Specialty Polymers.

Control Sample A further included a total of 26 parts per 100 parts curable perfluoropolymer of various fillers and a curative: N990 carbon black, N962 carbon black, organosilicone lubricant and a peroxide curative.

Control Sample B included a total of 15.9 total parts per 100 parts by weight curable perfluoropolymer of filler and curative: silicon carbide nanoparticles and a tetra-amine curative, 4,4′-[2,2,2-Trifluoro-1-(trifluoromethyl) ethylidene]bis[N1-phenyl-1,2-benzenediamine].

Control Sample C included 39 parts by weight per 100 parts by weight curable perfluoropolymer of fillers, curative and co-curative: PTFE powder, Aerosil™ R 972 silica, peroxide curative and triallyl isocyanurate (TAIC).

The same Control Samples A, B, and C were then evaluated as base formulations. To each of the Control Samples varying amounts of Novec™ 7500 were added based on 100 parts of the pre-mixed Control Sample Compositions to prepare inventive Samples. The amount of Novec™ 7500 added to each Control Sample Composition A, B or C for each of the inventive Samples A1, A2, A3, B1, B2, B3, C₁, C₂ and C₃ is shown below in Table A.

Control Sample A, and inventive Samples A1, A2 and A3 were cured for 10 min. at 320° F. Control Sample B, and inventive Samples B1, B2 and B3 were cured for 30 min. at 360° F. Control Sample C, and inventive Samples C1, C2 and C3 were cured for 8 min. at 300° F. Each sample was press cured without post cure.

To prepare the Sample C, The Tecnoflon® PFR-LT (having a Mooney viscosity of ML 1+10@ 121° C.) of 25) in an uncured state was added in a mixer and mixed for one minute. 15 g of Novec° 7500 plasticizer was added drop-by-drop for about 15-20 min and mixed for two minutes. The mixed compound in the mixture was banded in a C. W. Brabender type 6 model 60433 mill (16 in. mill), the nip was set at a setting point of 1.58 mm, and the compound was cut and blended for one minute. The compound was pig-rolled five times, and the mill setting was changed to 7.93 mm. The compound was sheeted to a final thickness of 7.93. Again, the nip was against closed having a nip point of 1.58 mm, and the compound was blended for a minute, rolled five times, and the mill setting was again changed to 7.93 mm, and the compound sheeted to a final thickness of 7.93 mm. The same procedure was used to prepare Samples of various levels of Novec™ 7500, and to prepare Samples A and B, only varying the components as noted above.

TABLE A

| | Amount (phr) of | Amount (phr) | | | | | | |
|---|---|---|---|---|---|---|---|---|
| | Base Form. | Novec ™ 7500 | T2, min. | T10, min | T50, min | T90, min | ML, lb-in | MH, lb-in |
| Contr. Sample A* | 100 | — | 1.75 | 1.19 | 2.77 | 6.81 | 1.166 | 10.018 |
| Sample A1** | 100 | 3 | 1.97 | 1.23 | 2.81 | 6.79 | 0.904 | 8.444 |
| Sample A2** | 100 | 9 | 1.91 | 1.21 | 2.63 | 6.44 | 0.585 | 7.175 |
| Sample A3** | 100 | 15 | 2.09 | 1.25 | 2.52 | 6.14 | 0.410 | 5.946 |
| Contr. Sample B* | 100 | — | 15.38 | 4.81 | 15.67 | 22.06 | 2.020 | 6.183 |
| Sample B1\hat{ } | 100 | 3 | 13.22 | 4.43 | 13.36 | 18.98 | 1.090 | 5.193 |
| Sample B2\hat{ } | 100 | 9 | 10.60 | 4.29 | 10.03 | 14.42 | 0.644 | 4.192 |
| Sample B3\hat{ } | 100 | 15 | 14.81 | 6.54 | 13.25 | 18.34 | 0.423 | 3.384 |
| Contr. Sample C* | 100 | — | 0.98 | 0.69 | 1.29 | 3.21 | 0.750 | 6.868 |
| Sample C1^{#} | 100 | 3 | 1.10 | 0.79 | 1.41 | 3.65 | 0.834 | 6.576 |
| Sample C2^{#} | 100 | 9 | 1.23 | 0.83 | 1.40 | 3.75 | 0.427 | 5.369 |
| Sample C3^{#} | 100 | 15 | 1.29 | 0.83 | 1.41 | 3.69 | 0.362 | 4.986 |

*MDR 360º F. for 30 min.
**MDR 320° F. for 15 min.
\hat{ }MDR 360º F. for 30 min.
#MDR 300° F. for 12 min.

As Table A shows, the inventive samples using 15 phr of Novec™ 7500 as the fluid plasticizer having a fluorinated organic compound showed a 64% decrease in ML (lb-in.) (Sample A3) in comparison to Control Sample A, a 79% decrease in ML (lb-in.)(Sample B3) in comparison to Control Sample B and a 52% decrease in ML (lb-in.)(Sample C3) in comparison to Control Sample C. This is a substantial decrease in ML torque indicating a substantial decrease in viscosity of the Control Compounds when the inventive compound is provided thereto indicating super plasticizer behavior.

The same samples also showed a significant decrease in hardness, which also indicates super plasticizer behavior as shown in Table B below.

TABLE B

| | Contr. | | | | Contr. | | | | Contr. | | | |
|---|---|---|---|---|---|---|---|---|---|---|---|---|
| Physical Properties | Sample | Sample | Sample | Sample | Sample | Sample | Sample | Sample | Sample | Sample | Sample | Sample |
| (no post cure) | A | A1 | A2 | A3 | B | B1 | B2 | B3 | C | C1 | C2 | C3 |
| Tensile Strength, psi | 2022 | 1508 | 1531 | 1368 | 1782 | 1391 | 1006 | 765 | 1121 | 982 | 566 | 504 |
| Elongation, % | 186 | 183 | 224 | 222 | 198 | 197 | 216 | 240 | 270 | 272 | 267 | 253 |
| Modulus @ 100%, psi | 1114 | 669 | 439 | 356 | 692 | 530 | 332 | 252 | 449 | 392 | 283 | 256 |
| Modulus @ 50%, psi | 426 | 275 | 203 | 169 | 352 | 266 | 179 | 148 | 329 | 305 | 224 | 200 |
| Specific Gravity | 2.02 | 2.01 | 2.00 | 1.99 | 2.12 | 2.11 | 2.09 | 2.06 | 1.97 | 1.97 | 1.95 | 1.93 |
| CE Hardness, Type M | 78.0 | 75.0 | 70.8 | 68.4 | 82.2 | 78.4 | 73.8 | 69.2 | 85.8 | 82.0 | 76.8 | 73.4 |
| CE Hardness, Type A | 70.0 | 69.0 | 64.0 | 60.4 | 68.8 | 66.2 | 61.8 | 56.9 | 74.5 | 70.7 | 65.3 | 61.7 |

TABLE C

| | Amount | | | | |
|---|---|---|---|---|---|
| | of (phr) | | TR10 | | Tg |
| | Novec ™ | TR10 | Improvement | | Improvement |
| Sample | 7500 | ° C. | ° C. | Tg (° C.) | (° C.) |
| Control | — | −4.1 | — | −4.6 | — |
| Sample A | | | | | |
| A1 | 3 | −10.1 | 3 | −11.1 | 6.5 |
| A2 | 9 | −20.7 | 19 | −22.7 | 18.1 |
| A3 | 15 | −26.9 | 23 | −32.0 | 27.4 |
| Control | — | −3.9 | — | −4.6 | — |
| Sample B | | | | | |
| B1 | 3 | −8.3 | 4.4 | −8.2 | 3.6 |
| B2 | 9 | −16.6 | 12.7 | −18.8 | 14.2 |
| B3 | 15 | −23.3 | 19.4 | −25.4 | 20.8 |
| Control | — | −15.5 | — | −31.7 | — |
| Sample C | | | | | |
| C1 | 3 | −19.1 | 2.0 | −37.8 | 6.1 |
| C2 | 9 | −31.7 | 9.0 | −46.8 | 15.1 |
| C3 | 15 | −38.4 | 12.7 | −47.2 | 15.5 |

### Example 2

Control Samples A, B and C were evaluated to determine the impact of the addition of Novec™ 7500 to the inventive Samples A1, A2 and A3, B1, B2 and B3 and C1, C2 and C3 from Example 1 with respect to the retraction temperature (TR10) and the glass transition temperature (Tg) of the compound. The Results are shown in Table C above. As can be seen, the increase in parts per hundred of the fluid plasticizer, Novec™ 7500, shows an improvement from the TR10 of Control Sample A for each additional part per hundred added of about 1.5° C. and an improvement for each part per hundred added in Tg of about 1.8° C. Control Sample B showed an increase in TR10 of about 1.3° C. for each part of the fluorinated organic compound in the fluid plasticizer added as well as an improvement in Tg for each part added of about 1.4° C. A similar effect was found in Control Sample C in which for each part per hundred of the fluorinated organic compound, the TR10 improved by 0.85° C. and the Tg improved about 1.0° C. The results are indicative of the ability of the fluid plasticizer having the fluorinated organic compound to provide a lower lowest use temperature to each Control Sample and showing a super low temperature plasticizer effect.

To further illustrate this improvement, low temperature O-ring leak tests were undertaken for each of the Control Samples A, B and C and the inventive Samples A1, A2, and A3; B1, B2, and B3; and C1, C2 and C3. The leak tests were performed as described in R. Campbell, “Improved Low Temperature Seals for Oil and Gas Applications,” Rubber World, pp. 44-52 (August 2022). Suitable leak tests include that described in SAE Technical Paper Series 2001-01-2974 and variations of that test as employed in the sealing industry, wherein seals are tested in a compressed state and are tested using low pressure nitrogen. See, Campbell, “Improved Low Temperature Seals for Oil and Gas Applications,” Rubber World, pp. 44-52 (August 2022).

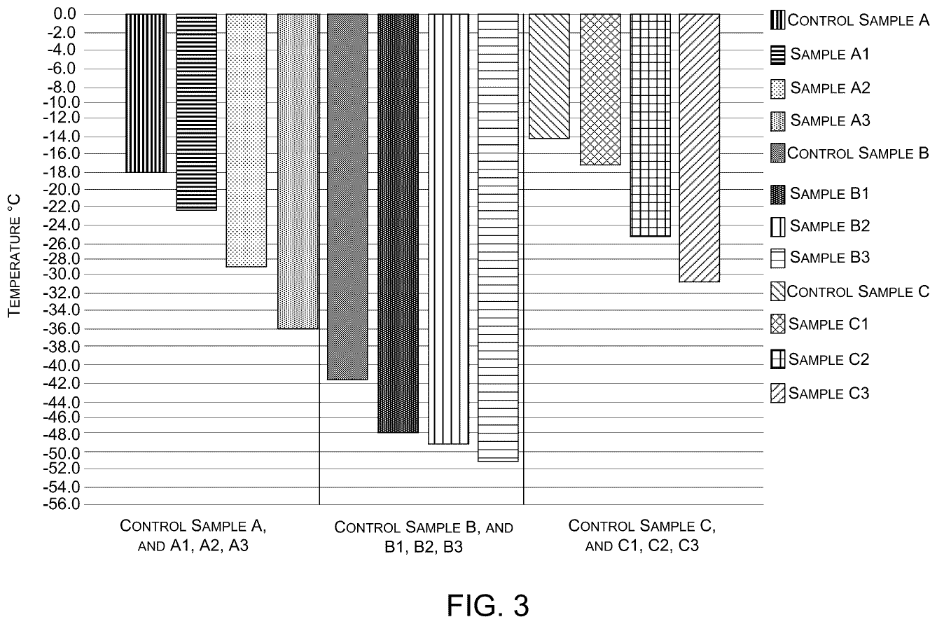

The results are shown in the graphical representation of FIG. 3 where the improvements in Tg and TR10 provide for a lower effective use temperature before leakage in the test. The low temperature leak test revealed further that the low temperature leak shifted from the value of the Control Sample A by adding 15 phr Novec™ 7500 (Sample A3) by 18.1° C., and from the value of the Control Sample C by adding 15 phr (Sample C3) by 9.4° C.; and from the Control Sample B by adding 15 phr (Sample B3) by 16° C.

### Example 3

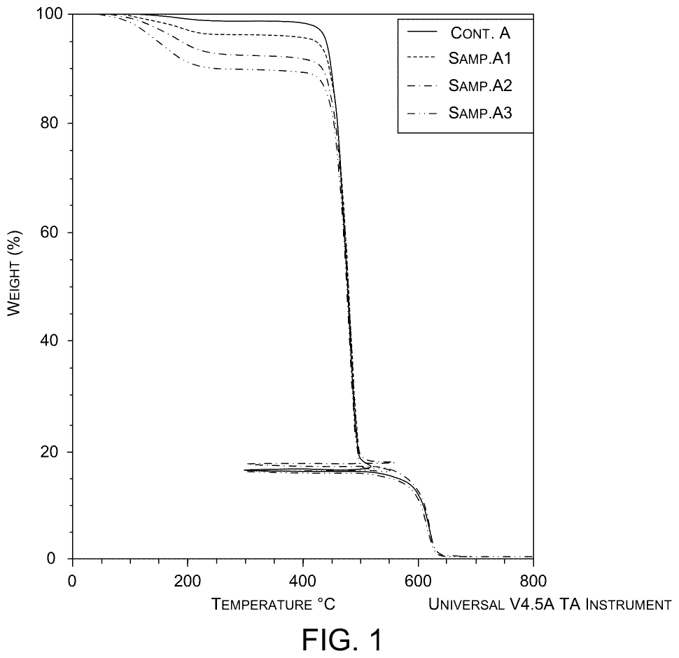

The samples were subjected to a TGA analysis which showed that the Novec™ 7500 baked out of the Samples A1, A2 and A3 from Example 1 between 200° C. and 300° C. See FIG. 1.

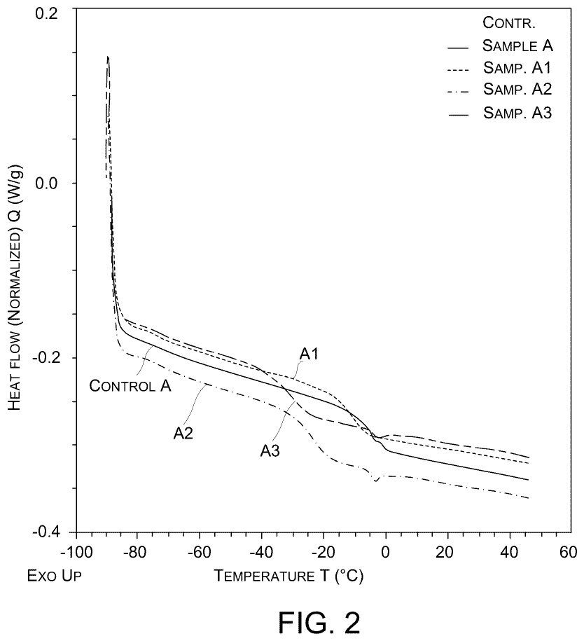

A differential scanning calorimetry (DSC) analysis was also run on the Control Sample A and inventive Samples A1, A2 and A3 as shown in FIG. 2, the DSC scan demonstrates the shift in Tg from the Control Sample A through each of the inventive Samples A1, A2 and A3 in view of the increasing content of Novec™ 7500 in each Sample. This is consistent with the data from Example 2 and Table C.

### Example 4

Formulations were prepared to demonstrate the improvement in torque (ML) using a a rubber process analyzer (RPA) for varying combinations of high Mooney viscosity fluorine-containing polymer alone and with a fluid plasticizer as described herein, and using a low Mooney viscosity polymer alone and with a plasticizer herein. Various combinations of such polymers were also combined with and without the plasticizer to illustrate changes in processability.

Compositions are shown in Table D below. Ten compounds (Compounds 1-10) were prepared using three different fluoroelastomer polymers: Tecnoflon™ VPL 75545 (having a Mooney viscosity (ML 1+10@ 121° C.) of 32; Tecnoflon™ VPL 45535 with a Mooney viscosity of 25 and Viton™ GLT 200S also with a Mooney viscosity of 25. Additives typically used in fluoroelastomer compounds including PTFE and silica were incorporated in sample Compounds 1-8, and varying curing agents used. Diak™ 7 was employed in Compounds 1-8, with either Varox™ DBPH or Varox™ 130XL. Two fluid plasticizers having organic fluorinated compounds, with one (Novec™ 7500) having a lower molecular weight than the other (Fomblin M60).

The fluoroelastomer compositions were prepared in similar manners. The procedure is explained with respect to the compounds having Tecnoflon™ VPL 45535. The polymer was weighed as 100 g, warmed on a mill, formed into strips that will fit into a mixer and added to the mixer to mix for one minute. Polyflon™ PTFE was added in an amount of 30 g into the mixture and mixed for 3 minutes. A pre-mixture of Aerosil™ R972, Varox™ DBPH (2,5-dimethyl-2,5-(t-butylperoxy) hexane) from R. T. Vanderbilt Company (1 gram) and Diak™ 7 (triallyl isocyanurate) from Chemours Company (5 grams), was added into the first mixture and mixed for 5 minutes. The compound mixture was added and dropped into a tight C. W. Brabender type 6 model 60433 mill and sheeted. It was cut and blended for 3 minutes, pig-rolled four times and sheeted out. It was cut into strips and extruded at 140° F. which was used for making seals or parts by compression molding and was introduced to an additive manufacturing process.

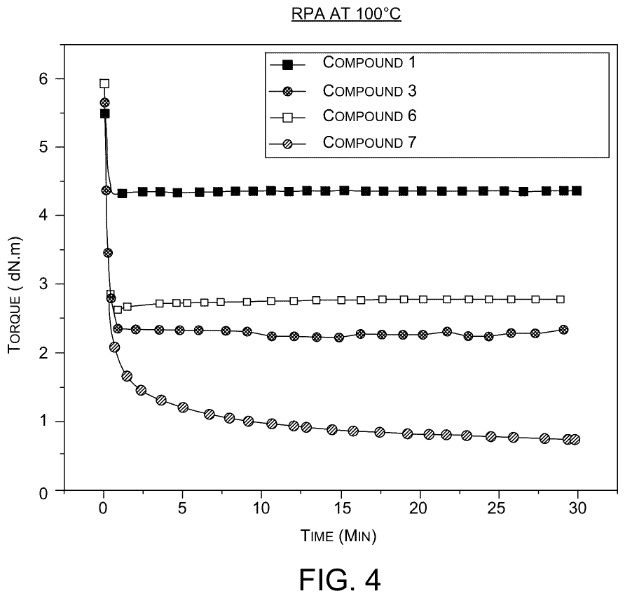

Sample Compounds 1, 3, 6 and 8 were analyzed on an RPA to evaluate torque (ML) in Compounds having lower Mooney viscosities of 32 and 25, for comparing the impact of use of a plasticizer in Compounds of varying Mooney viscosity. As shown in FIG. 4, the ML in each of the Compounds without plasticizer (Compounds 1 and 6) Compounds was decreased by the incorporation of a plasticizer (Compounds 3 and 8) regardless of the starting Mooney viscosity of the fluorine-containing elastomer used.

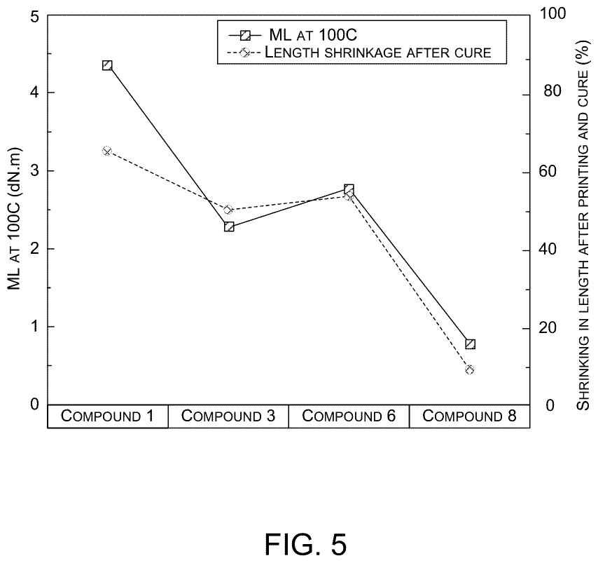

Parts formed from the compounds were tested for torque, interlayer adhesion and post print shrinkage. As shown in FIG. 5, the torque ML was measured at 100° C. for the four samples before and after an article was printed (showing the change post-cure) and also to show the percentage shrinkage post cure for the Compounds 1, 3, 6 and 8. Shrinkage and torque were lowest using the lower viscosity polymer of Compounds 6 and 8, with little shrinkage. The highest differential in shrinkage and highest torque is see using the higher viscosity polymer without the plasticizer in Compound 1.

TABLE D

| | Comp. | Comp. | Comp. | Comp. | Comp. | Comp. | Comp. | Comp. | Comp. | Comp. |
|---|---|---|---|---|---|---|---|---|---|---|
| Ingredient | 1 | 2 | 3 | 4 | 5 | 6 | 7 | 8 | 9 | 10 |
| Tecnoflon ™ VPL | 100 | 100 | 100 | 100 | 100 | — | — | — | — | — |
| 75545 | | | | | | | | | | |
| Technoflon ™ VPL | — | — | — | — | — | 100 | 100 | 100 | — | — |
| 45535 | | | | | | | | | | |
| Viton ™ GLT 200S | — | — | — | — | — | — | — | — | 100 | 100 |
| Polyflon ™ PTFE L-5F | 30 | 30 | 30 | 30 | 30 | 30 | 30 | 30 | — | — |
| Aerosil ™ R972 Silica | 5 | 5 | 5 | 5 | 5 | 5 | 5 | 5 | — | — |
| Diak ™ 7 | 3 | 3 | 3 | 3 | 3 | 3 | 3 | 3 | — | — |
| Varox ™ DBPH | 1 | — | 1 | — | 0.5 | 1 | 1 | 1 | — | — |
| Varox ™ 130XL | — | 2 | — | 2 | 1 | — | — | — | — | — |
| Novec ™ 7500* | — | — | 15 | 15 | 7.5 | — | — | — | — | — |
| Fomblin ™ M60 | — | — | — | — | — | — | 1 | 5 | — | 5 |

*low molecular weight
**high molecular weight

Sample Compounds 1-10 were introduced to an additive printing manufacturing process to print samples for evaluating processability and print quality. All Compounds were printable but the quality of Compounds 1 and 2 having a somewhat higher Mooney viscosity and no plasticizer were of poor quality. Compounds 3-5 each printed better than Compounds 1 and 2 due to the use of the plasticizers, however, some blistering occurred due to the higher viscosity and heat-contact. All of the lower Mooney viscosity Compounds 6-10 demonstrated good processability and printability showing no printing blister defects. Those having the plasticizer performed best in processability and printability.

The data show that formation of parts using additive printing of an FKM curable polymer having a Mooney viscosity that is over 30 without a plasticizer, can experience shrinkage after cure of about 67±9% as with Compound 1. Addition of a low molecular weight plasticizer as in Compound 3 in the Example herein reduced shrinkage 17% to 50±6%. Review of Compound 6 using a low Mooney viscosity FKM curable polymer of Mooney viscosity 25 demonstrated alone a similar shrinkage level to Compound 3 at 54±5% after cure. However, when a high molecular weight plasticizer was added in Compound 8, the shrinkage was only 6±1% after cure, which is a reduction of 48% from use of the plasticizer. This is demonstrated in FIG. 5. As the Example supports, use of a plasticizer can substantially or significantly reduce the Mooney viscosity of a fluoropolymer compound for use in flow or coating applications, such as additive printing or coatings. Theoretically, it is believed that the polymer chains experience less induced stress, as viscosity is directly proportional to induced stress. Reduced stress on the polymer chains imparts reduced strain, and when the chains relax and return to their intrinsic state of coiling, the degree of relaxation is to a lower degree in comparison to a compound of a higher viscosity. This results in reduced shrinkage in a finished and cured article.

It will be appreciated by those skilled in the art that changes could be made to the embodiments described above without departing from the broad inventive concept thereof. It is understood, therefore, that this invention is not limited to the particular embodiments disclosed, but it is intended to cover modifications within the spirit and scope of the present invention as defined by the appended claims.

1. A curable fluorine-containing composition, comprising
at least one curable fluorine-containing polymer; and
at least one fluid plasticizer comprising at least one, at least partially fluorinated organic compound,
wherein the at least one, at least partially fluorinated organic compound is capable of reducing viscosity and improving processability of a fluoroelastomer formed from the curable fluorine-containing polymer in the composition in comparison to a fluoroelastomer formed from the same curable fluorine-containing polymer without the at least one, at least partially fluorinated organic compound; and/or
wherein the at least one, at least partially fluorinated organic compound is capable of achieving a lowest use temperature of a fluoroelastomer formed from the curable fluorine-containing polymer that is lower than a lowest use temperature of a fluoroelastomer formed from the same curable fluorine-containing polymer without the at least one, at least partially fluorinated organic compound.

2. The curable fluorine-containing composition according to claim 1, further comprising at least one curative capable of curing the at least one curable fluorine-containing polymer.

3. The curable fluorine-containing composition according to claim 1, wherein the at least one curable fluorine-containing polymer is selected from the group consisting of an at least partially fluorinated fluoropolymer, a perfluorinated fluoropolymer, an at least partially fluorinated copolymer of tetrafluoroethylene and propylene, and an at least partially fluorinated silicone-containing polymer.

4. (canceled)

5. The curable fluorine-containing composition according to claim 3, wherein the at least one curable fluorine-containing polymer is a curable perfluorinated polymer and the curable perfluorinated polymer is a copolymer of tetrafluoroethylene, perfluoroalkylvinyl ether and at least one cure site monomer, wherein the at least one cure site monomer has a cure site that comprises a halogen atom or a nitrile group.

6. The curable fluorine-containing composition according to claim 3, wherein the at least one curable fluorine-containing polymer is an at least partially fluorinated polymer that includes a vinylidene fluoride monomer along its backbone, and/or includes vinylidene fluoride, hexafluoropropylene and tetrafluoroethylene as co-monomers along its backbone.

7. (canceled)

8. The curable fluorine-containing composition according to claim 1, wherein the at least one, at least partially fluorinated organic compound is selected from alkoxy fluoroalkanes, alkoxy fluoroalkenes, alkenoxy fluoroalkanes, alkenoxy fluoroalkenes, alkoxy perfluoroalkanes, alkoxy perfluoroalkenes, alkenoxy perfluoroalkanes, alkenoxy perfluoroalkenes, and combinations and mixtures thereof.

9. The curable fluorine-containing composition according to claim 1, wherein the at least one, at least partially fluorinated organic compound is a compound according to Formula (A):
(R_{af})(R_{b})_{y}—O—R_{c} (A)
wherein R_{af} is a fluorinated or perfluorinated alkane or alkene group of about 4 to about 20 carbon atoms, the fluorinated or perfluorinated alkane or alkene group is branched or straight chain and the fluorinated or perfluorinated alkane or alkene group comprises about 4 to about 41 fluorine atoms; R_{b} is an alkane of about 2 to about 5 carbon atoms; and y is 0 or 1;
wherein when y is 1, R_{b} is on a terminal end of R_{af}, or is within or depending from the carbon chain of R_{af}, and
wherein R_{c} is an alkane or alkene group of about 2 to about 7 carbon atoms and optionally has from 1 to about 3 fluorine atoms on the carbon atoms of the alkane or alkene group.

10. The curable fluorine-containing composition according to claim 9, wherein R_{af} and R_{b} are collectively about 4 to about 15 carbon atoms.

11. (canceled)

12. The curable fluorine-containing composition according to claim 9, wherein the O—R, group is a pendant alkoxy group or a pendant alkenoxy group on the carbon chain of (R_{af})(R_{b})_{y}.

13. The curable fluorine-containing composition according to claim 9, wherein O—R_{c} is an alkoxy group of about 2 to about 5 carbons.

14. The curable fluorine-containing composition according to claim 1, wherein the at least one, at least partially fluorinated organic compound is selected from methoxydecafluoroheptane and isomers thereof, ethoxy-nonafluorobutene ether and ethoxy-nonafluoroisobutyl ether isomers; ethoxy-trifluoromethylhexanes and isomers and derivatives thereof, and mixtures and combinations thereof.

15. The curable fluorine-containing composition according to claim 14, wherein the at least one, at least partially fluorinated organic compound is 3-ethoxy-1,1,1,2,3,4,5,5,6,6,6-dodecafluoromethylhexane.

16. The curable fluorine-containing composition according to claim 1, wherein the at least one, at least partially fluorinated organic compound is present in the composition at an amount of about 1 to about 20 parts by weight per hundred parts of the at least one curable fluorine-containing polymer.

17. The curable fluorine-containing composition according to claim 16, wherein the at least one, at least partially fluorinated organic compound is present in the composition in an amount of about 3 to about 15 parts by weight per hundred parts of the at least one curable fluorine-containing polymer.

18. The curable fluorine-containing composition according to claim 1, further comprising one or more additives or fillers different from the fluid plasticizer comprising the at least one, at least partially fluorinated organic compound, wherein the one or more additives or fillers are present in the composition in an amount of up to about 95 parts by weight per 100 parts of the curable fluorine-containing polymer.

19. The curable fluorine-containing composition according to claim 1, wherein the curable fluorine-containing composition is an additive manufacturing composition for use in printing a fluorine-containing elastomer article.

20. A cured fluoroelastomer composition comprising:
a fluoroelastomer that is at least partially cured; and
at least one, at least partially fluorinated organic compound in the matrix of the fluoroelastomer, wherein the at least one, at least partially fluorinated organic compound is incorporated in the matrix of the fluoroelastomer in a fluid plasticizer;
wherein the fluoroelastomer in the composition has a reduced viscosity and improved processability in comparison to a fluoroelastomer that is the same as the fluoroelastomer in the composition but does not include the at least one, at least partially fluorinated organic compound; and/or
wherein a lowest use temperature of the fluoroelastomer in the composition is lower than a lowest use temperature of a fluoroelastomer that is the same as the fluoroelastomer in the composition but does not include the at least one, at least partially fluorinated organic compound.

21. The fluoroelastomer composition according to claim 20, wherein a Tg of the fluoroelastomer in the composition, as measured in ° C., is at least about 30% lower than a Tg of a fluoroelastomer that is the same as the fluoroelastomer in the composition but that does not include the at least one, at least partially fluorinated organic compound.

22. The fluoroelastomer composition according to claim 20, wherein a minimum torque value (ML), as measured in lb-in, of a fluoroelastomer in the composition is at least about 50% lower than a minimum torque value of a fluoroelastomer that is the same as the fluoroelastomer in the composition but that does not include the at least one, at least partially fluorinated organic compound.

23. The fluoroelastomer composition according to claim 20, wherein the fluoroelastomer is selected from a cured at least partially fluorinated elastomer, a cured perfluoroelastomer, a cured at least partially fluorinated tetrafluoroethylene-propylene fluoroelastomer, and a cured at least partially fluorinated fluorosilicone.

24. (canceled)

25. The fluoroelastomer composition according to claim 20, wherein the at least one, at least partially fluorinated organic compound is selected from alkoxy fluoroalkanes, alkoxy fluoroalkenes, alkenoxy fluoroalkanes, alkenoxy fluoroalkenes, alkoxy perfluoroalkanes, alkoxy perfluoroalkenes, alkenoxy perfluoroalkanes, alkenoxy perfluoroalkenes, and combinations and mixtures thereof.

26. The fluoroelastomeric composition according to claim 20, wherein the at least one, at least partially fluorinated organic compound is a compound according to Formula (A):
(R_{af})(R_{b})_{y}—O—R_{c} (A)
wherein R_{af} is a fluorinated or perfluorinated alkane or alkene group of about 4 to about 20 carbon atoms, the fluorinated or perfluorinated alkane or alkene group is branched or straight chain and the fluorinated or perfluorinated alkane or alkene group comprises about 4 to about 41 fluorine atoms; R_{b} is an alkane of from about 2 to about 5 carbon atoms; and y is 0 or 1;
wherein when y is 1, R_{b} is on a terminal end of R_{af} or is within or depending from the carbon chain of R_{af}, and
wherein R_{c} is an alkane or alkene group of about 2 to about 7 carbon atoms and optionally has about 1 to about 3 fluorine atoms on the carbon atoms of the alkane or alkene group.

27. The fluoroelastomer composition according to claim 26, wherein R_{af} and R_{b} are collectively about 4 to about 15 carbon atoms.

28. (canceled)

29. The fluoroelastomer composition according to claim 26, wherein the O—R_{c} group is a pendant alkoxy group or a pendant alkenoxy group on the carbon chain of (R_{af})(R_{b})_{y}.

30. The fluoroelastomer composition according to claim 26, wherein O—R_{c} is an alkoxy group of about 2 to about 5 carbons.

31. The fluoroelastomer composition according to claim 20, wherein the at least one, at least partially fluorinated organic compound is selected from methoxydecafluoroheptane and isomers thereof, ethoxy-nonafluorobutene ether and ethoxy-nonafluoroisobutyl ether isomers; ethoxy-trifluoromethylhexanes and isomers and derivatives thereof, and mixtures and combinations thereof.

32. The fluoroelastomer composition according to claim 31, wherein the at least one, at least partially fluorinated organic compound is 3-ethoxy-1,1,1,2,3,4,5,5,6,6,6-dodecafluoromethylhexane

33. The fluoroelastomer composition according to claim 20, wherein the at least one, at least partially fluorinated organic compound is present in the fluoroelastomer composition at an amount of about 1 to about 20 parts by weight per hundred parts of the fluoroelastomer.

34. The fluoroelastomer composition according to claim 33, wherein the at least one, at least partially fluorinated organic compound is present in the fluoroelastomer composition in an amount of about 3 to about 15 parts by weight per hundred parts of the fluoroelastomer.

35. The fluoroelastomer composition according to claim 20, further comprising one or more additives or fillers different from the at least one, at least partially fluorinated organic compound, wherein the one or more additives or fillers are present in the composition in an amount of up to about 95 parts by weight per 100 parts of the fluoroelastomer.

36.-49. (canceled)
